(19) United States
(12) Patent Application Publication
(10) Pub. No.: US 2023/0116728 A1
(43) Pub. Date: Apr. 13, 2023

(54) SECONDARY BATTERY, BATTERY PACK, VEHICLE, AND STATIONARY POWER SUPPLY

(71) Applicant: KABUSHIKI KAISHA TOSHIBA, Tokyo (JP)

(72) Inventors: Yasuyuki Hotta, Tokyo (JP); Kazuomi Yoshima, Yokohama (JP); Keigo Hoshina, Yokohama (JP); Takashi Kuboki, Tokyo (JP); Shinsuke Matsuno, Tokyo (JP)

(73) Assignee: KABUSHIKI KAISHA TOSHIBA, Tokyo (JP)

(21) Appl. No.: 17/651,130

(22) Filed: Feb. 15, 2022

(30) Foreign Application Priority Data
Sep. 15, 2021 (JP) 2021-150420

(51) Int. Cl. H01M 4/66; H01M 4/62

(52) U.S. Cl. CPC H01M 4/668; H01M 4/625; H01M 4/667; H01M 2220/10; H01M 2220/20

(57) ABSTRACT

According to one embodiment, a secondary battery including an electrode and an aqueous electrolyte is provided. The electrode includes a resin current collector. The resin current collector includes a resin matrix and an electro-conductive filler. The aqueous electrolyte includes water.

### CROSS-REFERENCE TO RELATED APPLICATIONS

This application is based upon and claims the benefit of priority from Japanese Patent Application No. 2021-150420, filed Sep. 15, 2021, the entire contents of which are incorporated herein by reference.

### FIELD

Embodiments described herein relate generally to a secondary battery, a battery pack, a vehicle, and a stationary power supply.

### BACKGROUND

Nonaqueous electrolyte batteries such as lithium ion batteries are used as power sources in a wide range of fields. The forms of nonaqueous electrolyte batteries span over many, from small ones for various kinds of electronic devices and the like to large ones for electric vehicles and the like. The nonaqueous electrolyte batteries require safety measures since nonaqueous electrolytes containing flammable substances such as ethylene carbonate are used in the batteries.

As replacement for nonaqueous electrolyte batteries, development is in progress for aqueous electrolyte batteries using an aqueous electrolyte including an aqueous solution, which does not have flammability.

### BRIEF DESCRIPTION OF THE DRAWINGS

FIG. 1 is a sectional view schematically showing an example of a current collector contained in a secondary battery according to an embodiment;

FIG. 2 is a sectional view schematically showing another example of a current collector contained in the secondary battery according to the embodiment;

FIG. 3 is a sectional view schematically showing yet another example of a current collector contained in the secondary battery according to the embodiment;

FIG. 4 is a sectional view schematically showing an example of the secondary battery according to the embodiment;

FIG. 5 is a schematic sectional view of the secondary battery shown in FIG. 4 taken along a line V-V;

FIG. 6 is a partially cut perspective view schematically showing another example of the secondary battery according to the embodiment;

FIG. 7 is an enlarged sectional view showing section E of the secondary battery shown in FIG. 6;

FIG. 8 is a schematic sectional view representing an overview of a measurement of a contact angle with water;

FIG. 9 is a perspective view schematically showing an example of the battery module according to an embodiment;

FIG. 10 is a perspective view schematically showing an example of a battery pack according to an embodiment;

FIG. 11 is an exploded perspective view schematically showing another example of the battery pack according to the embodiment;

FIG. 12 is a block diagram showing an example of an electric circuit of the battery pack shown in FIG. 11;

FIG. 13 is a partially see-through diagram schematically showing an example of the vehicle according to an embodiment; and

FIG. 14 is a block diagram showing an example of a system including the stationary power supply according to an embodiment.

### DETAILED DESCRIPTION

According to one embodiment, a secondary battery including an electrode and an aqueous electrolyte is provided. The electrode includes a resin current collector. The resin current collector includes a resin matrix and an electro-conductive filler. The aqueous electrolyte includes water.

According to another embodiment, a battery pack including the secondary battery according to the above embodiment is provided.

According to yet another embodiment, a vehicle including the battery pack according to the above embodiment is provided.

According to still another embodiment, a stationary power supply including the battery pack according to the above embodiment is provided.

In a typical secondary battery, a metal body such as a metal foil is used as a current collector that is a substrate on which an electrode layer (active material-containing layer) containing an electrode material such as an electrode active material is supported. In an aqueous electrolyte battery using an aqueous electrolyte, gas generation may occur due to the electrolysis of water on a current collector made of metal. For example, hydrogen generation in the negative electrode, and oxygen generation in the positive electrode may occur, respectively. Such gas generation may lead to a decrease in the charge-discharge efficiency and a decrease in the lifetime of a battery.

Further, there exist metals that corrode due to the reaction with an aqueous electrolyte, and thus a metal material to be used for a current collector should be carefully selected. For example, for aluminum that has an advantage of being relatively lightweight, there is a concern of corrosion in an aqueous electrolyte. Titanium can be mentioned as a metal material resistant to corrosion, but is expensive and further has a high specific gravity of 4.5 g/cm³, and thus titanium is not preferable from the viewpoint of the energy density per weight. In addition, while it is known that hydrogen generation can be reduced by using zinc for a negative electrode current collector, the zinc current collector may dissolve depending on the charging and discharging conditions, and the maintenance of the electrode layer may be difficult.

Hereinafter, embodiments will be described with reference to the drawings. The same reference signs are applied to common components throughout the embodiments and overlapping explanations are omitted. Each drawing is a schematic view for explaining the embodiment and promoting understanding thereof; though there may be differences in shape, size and ratio from those in an actual device, such specifics can be appropriately changed in design taking the following explanations and known technology into consideration.

### First Embodiment

According to a first embodiment, provided is a secondary battery that includes an electrode including a resin current collector, and an aqueous electrolyte including water. The resin current collector includes a resin matrix and an electro-conductive filler. In the secondary battery, since the resin current collector is included as an electrode current collector, the electrode is made light and the gas generation (e.g., hydrogen generation or oxygen generation) at the electrode is suppressed, as well. Further, since the resin matrix does not dissolve in water, bonding is good between the resin current collector and the layer containing the electrode active material. Therefore, the secondary battery is high in energy density per weight and is excellent in life performance .

Such a secondary battery may include a positive electrode and a negative electrode . At least one of the positive electrode and the negative electrode includes an electrode including the above resin current collector. One of the positive electrode and the negative electrode may include the electrode including the resin current collector, or both of the positive electrode and the negative electrode may include the electrode including the resin current collector. It is preferable that the positive electrode and the negative electrode both include the resin current collector.

The electrode including the resin current collector may include an active material-containing layer supported on the resin current collector. The active material-containing layer contains an active material. The active material-containing layer may be arranged on at least one surface of the resin current collector. For example, an active material-containing layer may be provided on one surface of the resin current collector, or active material-containing layers may be arranged on one surface of the resin current collector and the reverse surface thereof. The active material-containing layer may further contain an electro-conductive agent and a binder, in addition to the active material.

The resin current collector contains a resin matrix, and an electro-conductive filler. The electro-conductive filler may be contained in a dispersed state in the resin matrix. The electro-conductive fillers dispersed in the resin matrix are linked with one another, whereby an electron conduction path is formed in the resin current collector. Thereby, the resin current collector can exhibit electrical conductivity, and functions as an electrode current collector.

The resin matrix includes polymeric materials, examples of which include polyolefins such as high-density polyethylene (HDPE), polypropylene (PP), and polymethylpentene (PMP); polyesters such as polyethylene terephthalate (PET) and polybutylene terephthalate (PBT); acrylates such as polymethyl acrylate (PMA) and polymethyl methacrylate (PMMA) ; polyvinyls such as polyvinyl chloride (PVC), polyvinylidene chloride (PVdC), polyvinylidene fluoride (PVdF), and polyacetal (POM); an acrylonitrile-butadiene-styrene resin (ABS resin); a modified-polyphenylene ether (m-PPE); and polyimides such as polyamideimide (PAI) and polyimide (PI). Further, the polymeric material included in the resin matrix may include a copolymer using the above resin, for example, a copolymer containing an ABS resin as a unit, or a polymer alloy in which the above resin is compounded.

The resin matrix desirably has a water absorption capacity of 0.001 wt% or more and 0.5 wt% or less. If the water absorption capacity of the resin matrix has such a low water absorption capacity, the resin current collector hardly swells due to the water contained in the aqueous electrolyte. When the resin current collector swells, the electron conduction path by the electro-conductive fillers linked in chain-form may be disrupted. Accordingly, in order to maintain the electrical conductivity of the resin current collector even in the secondary battery using an aqueous electrolyte, it is desirable that the water absorption capacity of the resin matrix is low.

The water absorption capacity of the resin matrix is a property that mainly depends on the water absorption capacity of the polymeric material included in the resin matrix. Specific examples of the water absorption capacity will be described by taking the above-described polymeric material as an example. The water absorption capacity of polyolefins is less than 0.01 wt%, the water absorption capacity of polyesters is from 0.1 wt% to 0.3 wt%, the water absorption capacity of acrylates is from 0.3 wt% to 0.5 wt%, the water absorption capacity of polyvinyls is from 0.05 wt% to 0.2 wt%, the water absorption capacity of an ABS resin is 0.2 wt%, the water absorption capacity of polyimides is from 0.3 wt% to 0.5 wt%, and the water absorption capacity of m-PPE is 0.07 wt%.

Examples of the electro-conductive filler include a carbon material and a metal material, which each have electrical conductivity. Specific examples of the carbon material include an acetylene black, a Ketjen black, graphite, coke, carbon fibers, and carbon nanotubes. Examples of the metal material include platinum, gold, silver, copper, nickel, titanium, iron, chromium, stainless steel, indium, tin, zinc, and aluminum, as well as alloys thereof . The electro-conductive filler may include one of these carbon and metal materials, or may include two or more in combination. From the viewpoint of weight reduction and resistance to corrosion and elution, a carbon material is preferably contained as the electro-conductive filler.

The form of the electro-conductive filler is not particularly limited, and may be in the form of, for example, particles, fibers, powder, scales, or the like.

The content of the electro-conductive filler is desirably 10 parts by mass or more and 120 parts by mass or less relative to 100 parts by mass of the resin matrix. The content of the electro-conductive filler is preferably 20 parts by mass or more. When the electro-conductive filler is contained in an amount of 10 parts by mass or more, the electrical conductivity of the resin current collector becomes favorable. Further, the content is preferably 100 parts by mass or less. From the viewpoint of the strength, the content of the electro-conductive filler is more preferably 90 parts by mass or less so as to increase the proportion of the resin matrix.

The resin current collector may contain an additive other than the electro-conductive filler. For example, the resin current collector may contain an antioxidant. The antioxidant acts as an oxidation inhibitor, and prevents the resin current collector from deteriorating due to oxidation. Between the positive electrode and the negative electrode, since the positive electrode is exposed to oxidation conditions, the resin current collector to which an antioxidant has been added can be more suitably used as the positive electrode current collector.

The content of the antioxidant is preferably 1 part by mass or more relative to 100 parts by mass of the resin matrix. By containing 1 part by mass or more of the antioxidant, a resin current collector having resistance to oxidation is obtained. From the viewpoint of the strength of the resin current collector, the content of the antioxidant is desirably 7 parts by mass or less.

As the antioxidant, it is desirable to use a compound that hardly dissolves in water. Specifically, the solubility of the antioxidant in water at room temperature is desirably 4 g/100 mL or less. By using such an antioxidant, a resin current collector that maintains the oxidation resistance over a long period of time is obtained. Examples of the antioxidant include hindered phenols such as 2,2ʹ-methylene bis(6-tert-butyl)-p-cresol, 2,4,6-tri-tert-butylphenol, 6-di-tert-butyl-4-ethylphenol, 2-tert-butyl-4,6-dimethylphenol, 2,2ʹ-methylene bis(4-ethyl-6-tert-butylphenol), isooctyl-3-(3,5-di-tert-butyl-4-hydroxyphenyl)propionate, pentaerythrityl-tetrakis(3-(3,5-di-tert-butyl-4-hydroxyphe nyl)propionate), octadecyl-3-(3,5-di-tert-butyl-4-hydroxyphenyl)propionate), 2,2ʹ-thiodiethylene bis(3-(3,5-di-tert-butyl-4-hydroxyphenyl)propionate), and 1,3,5-tris(3,5-di-tert-butyl-4-hydroxybenzyl)-1,3,5-triazi ne-2,4,6(1H,3H,5H)trione; semi-hindered phenols such as ethylene bis(oxyethylene) bis(3-(5-tert-butyl-hydroxy-m-tolyl)propionate), 3,9-bis(2-(3-(3-tert-butyl-4-hydroxy-5-methylphenyl)propio nyloxy)-1,1-dimethylethyl)-2,4,8,10-tetraoxaspiro(5,5)unde cane, and trithylene glycol bis(3-(3-tert-butyl-4-hydroxy-5-methylphenyl)propionate); and less-hindered phenols such as p-cresol, p-methoxyphenol, and (±) -α-tocopherol. In addition, as an additive for further improving the antioxidant effect, a phosphoric acid-based compound such as triphenyl phosphite, diphenyl isooctyl phosphite, diisooctyl phenyl phosphite, diphenyl decyl phosphite, diphenyl tridecyl phosphite, tris nonylphenyl phosphite, tris(2,4-di-tert-butylphenyl)phosphite, tris(2-tert-butylphenyl)phosphite, tris(2,4-di-(1,1-dimethylpropyl)phenyl)phosphite, or bis-(2,6-di-tert-butyl-4-methylphenyl)pentaerythritol-diph osphite can also be contained.

The antioxidant is preferably dispersed at least in the region near the surface of the resin current collector. This is because the oxidative deterioration proceeds on the surface of the resin current collector. The higher the content of the antioxidant is, the higher the effect of preventing the oxidative deterioration is. On the other hand, from the viewpoint of the strength of the resin current collector, it is preferable to reduce the amount of the antioxidant to be added so as to increase the proportion of the resin matrix. By unevenly distributing an antioxidant towards the surface of the resin current collector, the strength of the resin current collector can be enhanced while effectively preventing the oxidative deterioration on the surface. For example, a resin current collector having a multilayer structure including a surface layer containing an antioxidant and an inner layer not containing any antioxidant may be used. Specifically, a resin current collector having a layered structure, in which resin current collector sheets each having an antioxidant added are respectively stacked onto both the front and reverse surfaces of a resin current collector sheet without any antioxidant added, can be mentioned.

The resin current collector may have, for example, a plate shape, or a sheet shape. From the viewpoint of the energy density per unit volume of a secondary battery, a resin current collector having a thin-sheet shape or a thin-film shape is preferable. The shape of the resin current collector is not limited to the above examples. For example, the resin current collector may be a sheet having a thickness of 5 µm or more and 200 µm or less. In the above-described resin current collector with a multilayer structure, for example, the surface layer containing an antioxidant may have a thickness of 1 µm or more and 20 µm or less, and the inner layer not containing an antioxidant may have a thickness of 2 µm or more and 150 µm or less.

The resin current collector according to the embodiment may contain other components, as needed. Examples of the other components include a dispersant, a coloring agent, an ultraviolet ray absorber, and a plasticizer.

The resin current collector preferably has high water repellency. In a current collector with high water repellency, the oxidative decomposition and electrolysis of water are reduced, and thus, the oxidative deterioration of the current collector and the generation of gas such as oxygen or hydrogen are suppressed. Specifically, the contact angle with water on a surface of the resin current collector is preferably larger than 105°.

By introducing fluorine into a resin matrix on a surface of the resin current collector, the contact angle with water can be increased. Therefore, it is desirable that fluorine bonded to at least part of carbon contained in the resin matrix is contained on a surface of the resin current collector.

By performing fluorination treatment of the hydrocarbon of a polymeric material contained in the resin matrix, fluorine can be introduced. For example, by bringing a polymeric material into contact with fluorine gas (F₂) as in the example shown in the following formula, the hydrogen atom bonded to carbon can be substituted with a fluorine atom.

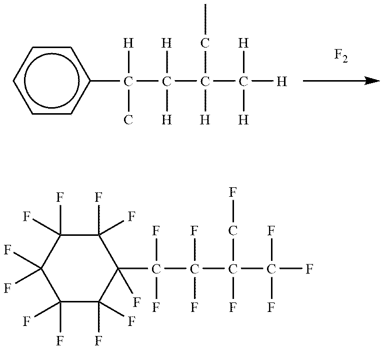

There is a tendency that the greater the degree of fluorination is, the higher the water repellency is and the larger the contact angle with water is. The surface abundance ratio of fluorine is preferably larger than the surface abundance ratio of carbon on a surface of a resin current collector. When there are more fluorine atoms than carbon atoms derived from a polymeric material of the resin matrix and a carbon-based electro-conductive filler present on a surface of the resin current collector, the oxidation reaction and electrolysis reaction of water hardly occur on the current collector surface, and a highly reliable secondary battery can be obtained. The abundance ratios of carbon and fluorine referred to herein can be determined by surface analysis with X-ray photoelectron spectroscopy (XPS) to be described later.

Further, by chemically modifying the surface of the resin current collector, the binding between the resin current collector and the active material-containing layer can be further strengthened. For example, by subjecting the surface of the resin current collector to plasma treatment, a polar group can be imparted onto the surface of the resin matrix. Specific examples of the polar group include a carbonyl group, and a hydroxyl group. By introducing a carbonyl group or hydroxyl group bonded onto the surface of the resin matrix, the amount of the oxygen contained on the surface of the resin current collector may become 1.2 times or more the amount of the oxygen contained inside . For example, the surface abundance ratio of oxygen in a resin current collector may be 1.2 times or more the abundance ratio of oxygen at a depth of 0.1 µm from the surface of the resin current collector. The abundance ratio of oxygen can be determined by XPS surface analysis to be described later.

Zinc may be contained on the surface of the resin current collector. Zinc may be present on the surface of the resin current collector, for example, as metal zinc (zinc element) or a compound of zinc (for example, zinc oxide or zinc hydroxide) . By containing zinc in such a form on the current collector surface, as well, the binding between the resin current collector and the active material-containing layer can be enhanced. In addition, since the hydrogen generation potential of zinc is low, the hydrogen generation hardly occurs in a resin current collector containing zinc. Accordingly, by using the resin current collector containing zinc as a negative electrode current collector, the effect of suppressing the hydrogen generation can also be obtained.

By having zinc or a compound of zinc be present mainly on a surface of the resin current collector, the effects of improving the binding property and suppressing the hydrogen generation can be obtained, but it is desirable to reduce the zinc content inside the resin current collector. By limiting the zinc content inside the current collector low, the strength reduction of the internal structure due to the elution of zinc accompanying the charge and discharge in an aqueous electrolyte can be prevented. Specifically, the surface abundance ratio of the zinc on the surface of the resin current collector is desirably 1.2 times or more the abundance ratio of the zinc at a depth of 0.1 µm from the surface of the resin current collector. The abundance ratio of zinc can be determined by XPS surface analysis to be described later.

In order to provide zinc or a zinc compound on the resin current collector surface, for example, deposition can be performed by a plating treatment or by performing charge and discharge in a state in which a zinc salt is added to the aqueous electrolyte. The zinc or zinc compound is deposited and formed mainly on electro-conductive filler that may be exposed on a surface of the resin current collector. For this reason, an active material-containing layer can be bound to a portion of the resin matrix that has not been covered with zinc on the resin current collector surface. Accordingly, even in a case where zinc elution occurs due to charging and discharging, binding between the resin current collector and the active material-containing layer can be maintained. Further, the portion of electro-conductive filler may be covered with zinc while a polar group is introduced into the portion of the resin matrix. The covering treatment may be performed in a state in which the active material-containing layer is supported.

An example of the resin current collector contained in the secondary battery according to the embodiment will be described with reference to the drawings.

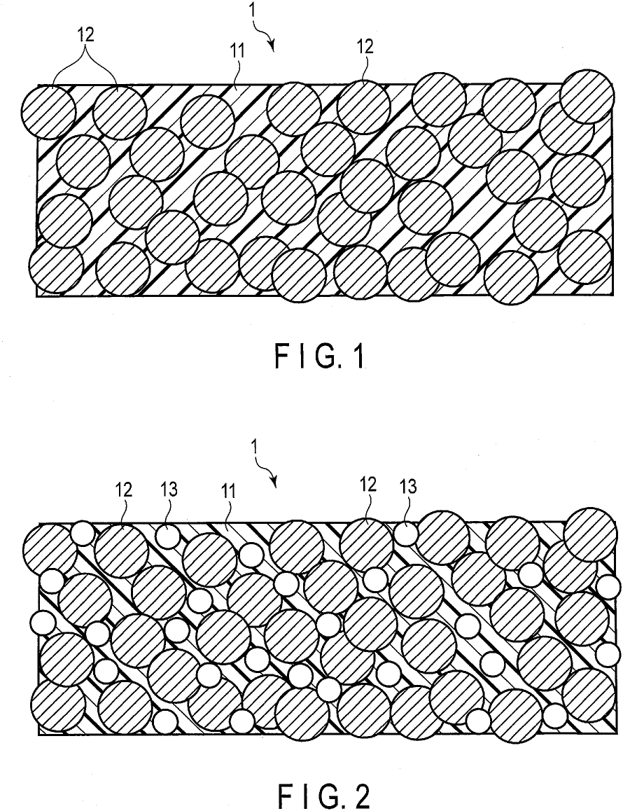

FIG. 1 is a cross-sectional view schematically showing an example of a current collector contained in the secondary battery according to the embodiment. The shown resin current collector 1 contains a resin matrix 11, and electro-conductive fillers 12. The electro-conductive fillers 12 are dispersed within the resin matrix 11. By the contact between the dispersed electro-conductive fillers 12, an electron conduction path is formed within the resin current collector 1.

FIG. 2 is a cross-sectional view schematically showing another example of a current collector contained in the secondary battery according to the embodiment. The resin current collector 1 in this example further contains antioxidants 13 in addition to the resin matrix 11 and the electro-conductive fillers 12. Since the antioxidants 13 are contained, the resin current collector 1 can have resistance to deterioration due to oxidation.

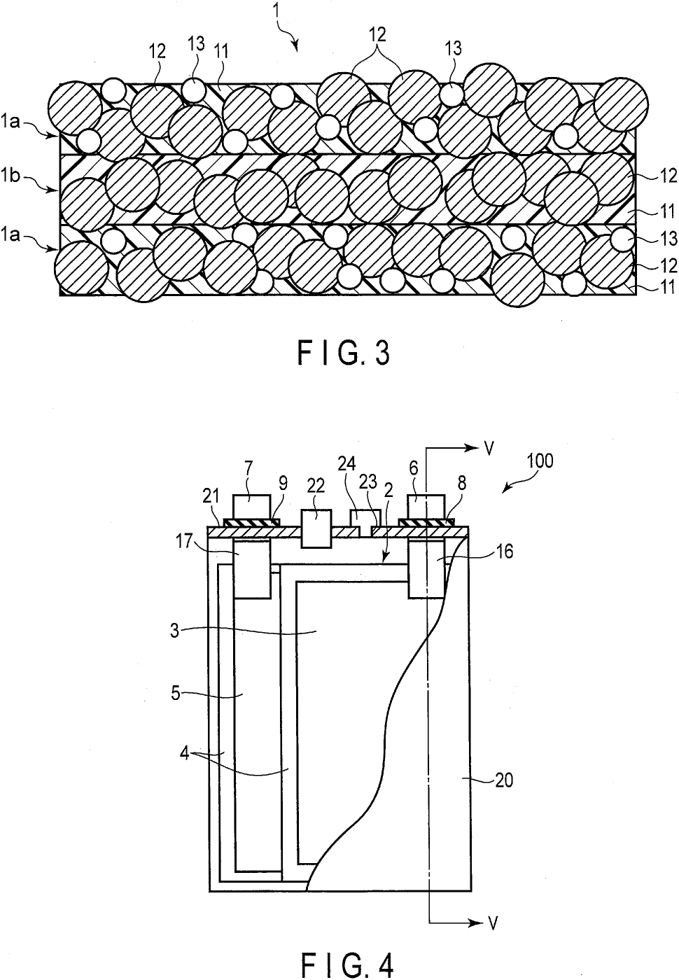

FIG. 3 is a cross-sectional view schematically showing still another example of a current collector contained in the secondary battery according to the embodiment. The resin current collector 1 in this example corresponds to a preferred embodiment in a case of containing an antioxidant 13. In the shown example, the resin current collector 1 has a multilayer structure in which surface layers 1a each containing a resin matrix 11, electro-conductive fillers 12, and antioxidants 13 are stacked onto both the front and reverse principal surfaces of an inner layer 1b containing only a resin matrix 11 and electro-conductive fillers 12. In the resin current collector 1 with a multilayer structure, since the surface layers 1a on the outer surface sides have antioxidant effects and the inner layer 1b on the inner side has high mechanical strength, both of the oxidation resistance and the strength can be achieved.

The resin current collector can be prepared, for example, as follows. A polymeric material as a raw material for a resin matrix, an electro-conductive filler, and optionally an additive such as an antioxidant are kneaded together. During the kneading, the materials are melted by heating. A sheet-shaped resin current collector can be prepared by rolling the resin current collector material obtained by melt-kneading, with a heating roll.

Hereinafter, the secondary battery according to the embodiment will be described in detail.

The secondary battery according to the embodiment may further include a separator disposed between the positive electrode and the negative electrode. In such a case, at least a part of the separator is present between the positive electrode and the negative electrode. The positive electrode, the negative electrode, and the separator may configure an electrode group. The electrode group may hold the aqueous electrolyte. The secondary battery may further include a container member capable of housing the electrode group and the aqueous electrolyte.

In addition, the secondary battery may further include a negative electrode terminal electrically connected to the negative electrode and a positive electrode terminal electrically connected to the positive electrode.

The secondary battery according to the embodiment is a rechargeable storage battery in which a carrier ion (for example, a lithium ion) moves back and forth between the positive electrode and the negative electrode, whereby electric power can be charged and discharged. More specifically, the secondary battery is a secondary battery in which charge and discharge are performed by a carrier ion being inserted into/extracted from an electrode active material at each of the positive electrode and the negative electrode. The secondary battery according to the embodiment differs from an electrochemical cell for sample measurement, a fuel cell, or the like and may be a lithium ion secondary battery, a sodium ion secondary battery, or a magnesium secondary battery, for example. In addition, the secondary battery includes an aqueous electrolyte secondary battery including an aqueous electrolyte (e.g., an aqueous solution electrolyte). Namely, the secondary battery may be an aqueous electrolyte lithium ion secondary battery, aqueous electrolyte sodium ion secondary battery, or aqueous electrolyte magnesium ion secondary battery.

Hereinafter, the aqueous electrolyte, negative electrode, positive electrode, separator, container member, negative electrode terminal, and positive electrode terminal will be described in detail.

### Aqueous Electrolyte

The aqueous electrolyte contains an aqueous solvent and an electrolyte salt.

As the electrolyte salt, there may be used, for example, a lithium salt, a sodium salt, or a mixture thereof . One species, or two species or more of electrolyte salts may be used.

There may be used as the lithium salt, for example, lithium chloride (LiCl), lithium bromide (LiBr), lithium hydroxide (LiOH), lithium sulfate (Li₂SO₄), lithium nitrate (LiNO₃), lithium acetate (CH₃COOLi), lithium oxalate (Li₂C₂O₄), lithium carbonate (Li₂CO₃), lithium bis (trifluoromethanesulfonyl) imide (LiTFSI: LiN(SO₂CF₃)₂), lithium bis (fluorosulfonyl) imide (LiFSI: LiN(SO₂F)₂), lithium bis (oxalate) borate (LiBOB; LiB [(OCO)₂]₂), or the like.

There may be used as the sodium salt, for example, sodium chloride (NaCl), sodium sulfate (Na₂SO₄), sodium hydroxide (NaOH), sodium nitrate (NaNOₛ), sodium trifluoromethanesulfonyl amide (NaTFSA), or the like.

As the electrolyte salt, an inorganic salt is preferably used. Examples of lithium salt which is an inorganic salt include LiCl, LiBr, LiOH, Li₂SO₄, and LiNO₃. Examples of the sodium salt which is an inorganic salt include NaCl, Na₂SO₄, NaOH, and NaNO₃. The aqueous electrolyte containing the inorganic salt as the electrolyte salt at high concentration does not freeze even at a low temperature of about -60° C., and thus allows widening of a use environment in which the secondary battery can be used.

As the lithium salt, LiCl is preferably contained. When LiCl is used, the lithium ion concentration of the aqueous electrolyte can be made high. Additionally, the lithium salt preferably contains at least one of Li₂SO₄ and LiOH in addition to LiCl.

The mol concentration of carrier ions (e.g., lithium ions or sodium ions) in the aqueous electrolyte is preferably 3 mol/L or more, more preferably 6 mol/L or more, and further preferably 12 mol/L or more. When the concentration of the carrier ions in the aqueous electrolyte is high, electrolysis of the aqueous solvent at the negative electrode can easily be suppressed, and hydrogen generation from the negative electrode tends to be little.

In addition, aside from the lithium salts and sodium salts, zinc salts such as zinc chloride and zinc sulfate may be added to the electrolyte. By addition of such compounds to the electrolyte, for example, a film containing zinc or a zinc compound may be formed at the negative electrode. The zinc or zinc compound included in the negative electrode exhibit the effect of suppressing hydrogen generation in the negative electrode.

The aqueous electrolyte may be, for example, liquid. The liquid aqueous electrolyte is an aqueous solution prepared by dissolving an electrolyte salt as a solute in an aqueous solution. In the aqueous electrolyte, the aqueous solvent amount is preferably 1 mol or more relative to 1 mol of electrolyte salt as solute. In a more preferable form, the aqueous solvent amount relative to 1 mol of the salt as solute is 3.5 mol or more.

The aqueous electrolyte preferably contains, as an anion species, at least one selected from the group consisting of a chloride ion (Cl-), a hydroxide ion (OH-), a sulfate ion (SO₄²-), and a nitrate ion (NO₃⁻).

The aqueous electrolyte may be a gel electrolyte. The gel electrolyte is prepared by obtaining a composite of the above liquid aqueous electrolyte and a polymeric material. Examples of the polymeric material include polyvinylidene fluoride (PVdF), polyacrylonitrile (PAN), polyethylene oxide (PEO), and mixtures thereof.

As the aqueous solvent, a solution including water may be used. Here, the solution including water may be pure water or a solvent mixture of water and an organic solvent. The aqueous solvent includes water in a proportion of 50% or more by volume, for example. The aqueous solvent preferably includes water in proportion of 90% or more by volume.

The pH of the aqueous electrolyte is preferably 3 to 14, and more preferably 4 to 14. The pH herein is of a value measured at 25° C.

The inclusion of water in the aqueous electrolyte can be examined by GC-MS (Gas Chromatography - Mass Spectrometry). In addition, the salt concentration and the water content in the aqueous electrolyte can be measured by, for example, ICP (Inductively Coupled Plasma) emission spectrometry. The molar concentration (mol/L) can be calculated by measuring a predetermined amount of aqueous electrolyte and calculating the concentration of contained salt. In addition, the number of moles of the solute and the solvent can be calculated by measuring the specific gravity of the aqueous electrolyte.

### Negative Electrode

The negative electrode may include a negative electrode current collector, and a negative electrode active material-containing layer supported on one face or both of reverse faces of the negative electrode current collector.

The negative electrode current collector may be the above-mentioned resin current collector. In a secondary battery where the positive electrode includes the above resin current collector, the negative electrode current collector may be a current collector different from the resin current collector. For other negative electrode current collectors, there may be used as material, a substance which is electrochemically stable at the negative electrode potential range when alkali metal ions are inserted into and extracted from the active material of the negative electrode. The other negative electrode current collector is preferably a foil made of a metal, such as nickel, stainless steel, iron, copper, zinc, titanium, and the like, an aluminum foil, or an aluminum alloy foil containing at least one selected from the group consisting of magnesium (Mg), titanium (Ti), zinc (Zn), manganese (Mn), iron (Fe), copper (Cu), and silicon (Si). The other negative electrode current collector may be of another form such as a porous body or a mesh. The thickness of the other negative electrode current collector is preferably 5 µm to 50 µm. With a current collector having such a thickness, balance can be kept between the strength of the electrode and weight reduction.

The negative electrode current collector may include a portion where the negative electrode active material-containing layer is not formed on a surface thereof. This portion may serve as a negative electrode current collecting tab.

The negative electrode active material-containing layer contains a negative electrode active material. The negative electrode active material-containing layer may be disposed on at least one face of the negative electrode current collector. For example, the negative electrode active material-containing layer may be disposed on one face of the negative electrode current collector, or the negative electrode active material-containing layer may be disposed on one face and a reverse face of the negative electrode current collector.

The porosity of the negative electrode active material-containing layer is preferably 15% to 50%. In this range, the negative electrode both excellent in affinity with the electrolyte and is of high density can be obtained. The porosity of the negative electrode active material-containing layer is more preferably 20% to 40%.

The porosity of the negative electrode active material-containing layer can be obtained by, for example, mercury porosimetry. More specifically, first, the pore distribution of the active material-containing layer is obtained by mercury porosimetry. Next, the total pore amount is calculated from the pore distribution. Next, the porosity can be calculated from the ratio of the total pore amount and the volume of the active material-containing layer.

As the negative electrode active material, for example, there may be used a compound whose lithium ion insertion/extraction potential is 1 V (vs. Li/Li⁺) to 3 V (vs. Li/Li⁺) in terms of a potential based on metal lithium (a potential with respect to an oxidation-reduction potential of lithium). As the negative electrode active material, more specifically, a titanium-containing oxide may be used. As the titanium-containing oxide, an oxide of titanium, a lithium titanium composite oxide, a niobium titanium composite oxide, a sodium titanium composite oxide, an orthorhombic titanium-containing oxide, and the like may be used. One species or two species or more of the titanium-containing oxides maybe included in the negative electrode active material.

The oxide of titanium includes, for example, a titanium oxide having a monoclinic structure, a titanium oxide having a rutile structure, and a titanium oxide having an anatase structure. For titanium oxides of these crystal structures, the composition before charge can be expressed as TiO₂, and the composition after charge can be expressed as LiₓTiO₂ . Here, x satisfies 0 ≤ x ≤ 1. In addition, the structure of titanium oxide having a monoclinic structure before charge can be expressed as TiO₂(B).

The lithium titanium oxide includes, for example, a lithium titanium oxide having a spinel structure (for example, a compound represented by general formula Li_{4+w}Ti₅O₁₂, where -1 ≤ w ≤ 3), a lithium titanium oxide having a ramsdellite structure (for example, a compound represented by Li_{2+w}Ti₃O₇, where -1 ≤ w ≤ 3) , a compound represented by Li₁₊ₓTi₂O₄ where 0 ≤ x ≤ 1, a compound represented by Li_{1.1+x}Ti_{1.8}O₄ where 0 ≤ x ≤ 1, a compound represented by Li_{1.07+x}Ti_{1.86}O₄ where 0 ≤ x ≤ 1, a compound represented by LiᵥTiO₂ where 0 < v ≤ 1) , and the like. The lithium titanium oxide may be a lithium titanium composite oxide having a dopant introduced.

The niobium titanium composite oxide include, for example, a compound represented as Li_{y}TiM_{z}Nb_{2±β}O_{7+σ}, where 0 ≤ y ≤ 5, 0 ≤ z ≤ 0.3, 0 ≤ β ≤ 0.3, 0 ≤ σ ≤ 0.3, and M is at least one selected from the group consisting of Fe, V, Mo, and Ta.

The sodium titanium composite oxide include, for example, an orthorhombic Na-containing niobium titanium composite oxide represented by the general formula Li₂₊ₐNa_{2—b}M1_{c}Ti_{6—d—e}Nb_{d}M2ₑO_{14+δ}, where 0 ≦ a ≦ 4, 0 ≦ b < 2, 0 ≦ c < 2, 0 < d < 6, 0 ≦ e < 3, d + e < 6, -0.5 ≦ 5 ≦ 0.5, M1 includes at least one selected from the group consisting of Cs, K, Sr, Ba, and Ca, and M2 includes at least one selected from the group consisting of Zr, Sn, V, Ta, Mo, W, Fe, Co, Mn, and A1.

The orthorhombic titanium-containing composite oxide include, for example, a compound represented by Li_{2+f}Mα_{2—g}Ti_{6—h}MβⱼO_{14+δ}. Here, Mα is at least one selected from the group consisting of Sr, Ba, Ca, Mg, Na, Cs, Rb and K. Mβ is at least one selected from the group consisting of Zr, Sn, V, Nb, Ta, Mo, W, Y, Fe, Co, Cr, Mn, Ni and Al. The respective subscripts in the composition formula are specified as follows : 0 ≤ f ≤ 6, 0 ≤ g < 2, 0 ≤ h < 6, 0 ≤ j < 6, and -0.5 ≤ δ ≤ 0.5. Specific examples of the orthorhombic titanium-containing composite oxide include Li_{2+f}Na₂Ti₆O₁₄, where 0 ≤ f ≤ 6.

As the negative electrode active material, the titanium oxide having the anatase structure, the titanium oxide having the monoclinic structure, the lithium titanium oxide having the spinel structure, or a mixture thereof is preferably used. When one of these oxides is used as the negative electrode active material and, for example, a lithium manganese composite oxide is used as the positive electrode active material, a high electromotive force can be obtained.

The negative electrode active material may be contained in the negative electrode active material-containing layer in a form of, for example, particles. The negative electrode active material particles may be primary particles, secondary particles that are agglomerates of primary particles, or a mixture of singular primary particles and secondary particles. The shape of a particle is not particularly limited and may be, for example, spherical, elliptical, flat, or fibrous.

The average particle size (diameter) of the primary particles of the negative electrode active material is preferably 3 µm or less, and more preferably 0.01 µm to 1 µm. The average particle size (diameter) of the secondary particles of the negative electrode active material is preferably 30 µm or less, and more preferably 5 µm to 20 µm.

Each of the primary particle size and the secondary particle size means a particle size with which a volume integrated value becomes 50% in a particle size distribution obtained by a laser diffraction particle size distribution measuring apparatus. As the laser diffraction particle size distribution measuring apparatus, Shimadzu SALD-300 is used, for example. For measurement, luminous intensity distribution is measured 64 times at intervals of 2 seconds. As a sample used when performing the particle size distribution measurement, a dispersion obtained by diluting the negative electrode active material particles by N-methyl-2-pyrrolidone such that the concentration becomes 0.1 mass% to 1 mass% is used. Alternatively, used is a measurement sample obtained by dispersing 0.1 g of a negative electrode active material in 1 ml to 2 ml of distilled water containing a surfactant.

The negative electrode active material-containing layer may contain an electro-conductive agent, a binder, and the like in addition to the negative electrode active material. The electro-conductive agent is mixed as needed to raise current collection performance and suppress the contact resistance between the active material and the current collector. The binder has a function of binding the active material, the electro-conductive agent, and the current collector.

Examples of the electro-conductive agent include carbon materials such as acetylene black, Ketjen black, graphite, coke, carbon fiber, and carbon nanotube. The electro-conductive agent may be of one species, or two species or more may be used in mixture.

As the binder for the negative electrode, there may be used, for example, at least one selected from the group consisting of polytetrafluoroethylene (PTFE), polyvinylidene fluoride (PVdF), a cellulose-based polymer such as carboxymethyl cellulose (CMC) , fluorine-based rubber, styrene butadiene rubber, an acrylic resin or a copolymer thereof, polyacrylic acid, and polyacrylonitrile (PAN). The binder is not limited to the above. The binder may be of one species, or two or more species may be used in mixture.

The mixing ratios of the electro-conductive agent and binder with respect to 100 parts by mass of active material in the negative electrode active material-containing layer are preferably 1 part by mass to 20 parts by mass and 0.1 part by mass to 10 parts by mass, respectively. If the mixing ratio of the electro-conductive agent is 1 part by mass or more, the electrical conductivity of the negative electrode can be favorable. If the mixing ratio of the electro-conductive agent is 20 parts by mass or less, decomposition of the aqueous electrolyte on the electro-conductive agent surface can be reduced. If the mixing ratio of the binder is 0.1 part by mass or more, a sufficient electrode strength can be obtained. If the mixing ratio of the binder is 10 parts by mass or less, the insulating portions in the electrode can be decreased.

More preferably, the negative electrode contains zinc. Zinc may be present on the surface of the negative electrode active material as metallic zinc (elemental zinc) or a compound of zinc (for example, zinc oxide or zinc hydroxide) . Also, as the current collector of the negative electrode (in the case of not using the resin current collector), a material containing zinc such as zinc foil or a zinc-containing alloy may be used. In the case of using the resin current collector as the negative electrode, as well, metallic zinc or zinc compound may be included on a surface thereof. Zinc present on the surface of the negative electrode active material may be, for example, zinc eluted from a zinc-including current collector when the current collector including zinc is used for the negative electrode or zinc ions derived from a zinc salt added to the aqueous electrolyte, that has deposited onto the negative electrode at the time of initial charge. Zinc contained in the negative electrode raises the hydrogen generation overvoltage at the negative electrode. Therefore, an effect of suppressing hydrogen generation is further obtained.

The negative electrode can be obtained by, for example, the following method. First, the active material, electro-conductive agent, and binder are suspended in a suitable solvent to prepare a slurry. Next, the slurry is applied onto one surface or both surfaces of the current collector. The coating of applied slurry on the current collector is dried, thereby forming an active material-containing layer. After that, pressing is performed for the current collector and the active material-containing layer formed thereon. As the active material-containing layer, the mixture of the active material, electro-conductive agent, and binder may be formed into pellets and used.

### Positive Electrode

The positive electrode may include a positive electrode current collector and a positive electrode active material-containing layer supported on at least one principal surface of the positive electrode current collector.

The positive electrode current collector may be the above-mentioned resin current collector. In a secondary battery where the negative electrode includes the above resin current collector, the positive electrode current collector may be a current collector different from the resin current collector. The other positive electrode current collector contains, for example, an alloy such as stainless steel, and metals such as aluminum (Al) and titanium (Ti). The other positive electrode current collector may have a form of, for example, a foil, a porous body, or a mesh. The surface of the other positive electrode current collector may be covered with a different element in order to prevent corrosion by the reaction between the other positive electrode current collector and the aqueous electrolyte. The other positive electrode current collector is preferably a material with excellent corrosion resistance and oxidation resistance such as Ti foil and the like, for example.

The positive electrode active material-containing layer contains a positive electrode active material. The positive electrode active material-containing layer may be supported on one principal surface of the positive electrode current collector. Alternatively, the positive electrode active material-containing layer may be supported on both of reverse principal surfaces of the positive electrode current collector.

As the positive electrode active material, there may be used a compound whose lithium ion insertion/extraction potential is 2.5 V (vs. Li/Li⁺) to 5.5 V (vs. Li/Li⁺) in terms of a potential based on metal lithium (a potential with respect to an oxidation-reduction potential of lithium) . The positive electrode may contain one species of positive electrode active material or may contain two or more species of positive electrode active materials.

Examples of the positive electrode active material include a lithium manganese composite oxide, a lithium nickel composite oxide, a lithium cobalt aluminum composite oxide, a lithium nickel cobalt manganese composite oxide, a lithium manganese nickel composite oxide having a spinel structure, a lithium manganese cobalt composite oxide, lithium iron oxide, lithium iron fluorosulfate, a phosphate compound having an olivine crystal structure (for example, a compound represented by LiᵥFePO₄ where 0 < v ≤ 1, or a compound represented by LiᵥMnPO₄ where 0 < v ≤ 1), and the like. The phosphate compound having an olivine crystal structure has excellent thermal stability.

Examples of the positive electrode active material with which a high positive electrode potential can be obtained include a lithium manganese composite oxide such as a compound having a spinel structure represented by LiᵥMn₂O₄ where 0 < v ≤ 1, and a compound represented by LiᵥMnO₂ where 0 < v ≤ 1; a lithium nickel aluminum composite oxide such as a compound represented by LiᵥNi_{1—u}AlᵤO₂ where 0 < v ≤ 1 and 0 < u < 1; a lithium cobalt composite oxide such as a compound represented by LiᵥCoO₂ where 0 < v ≤ 1; a lithium nickel cobalt composite oxide such as a compound represented by LiᵥNi_{1—u—t}CoᵤMnₜO₂ where 0 < v ≤ 1, 0 < u < 1, and 0 ≤t < 1; a lithium manganese cobalt composite oxide such as a compound represented by LiᵥMnᵤCo_{1—u}O₂ where 0 < v ≤ 1 and 0 < u < 1; a lithium manganese nickel composite oxide having a spinel structure such as a compound represented by LiᵥMn_{1—r}NiᵣO₄ where 0 < v ≤ 1, 0 < r < 2, and 0 < 1-r < 1; a lithium phosphate having an olivine structure such as a compound represented by LiᵥFePO₄ where 0 < v ≤ 1, a compound represented by LiᵥFe_{1—x}MnₓPO₄ where 0 < v ≤ 1 and 0 ≤ x ≤ 1, and a compound represented by LiᵥCoPO₄ where 0 < v ≤ 1, and an iron fluorosulfate (for example, a compound represented by LiᵥFeSO₄F where 0 < v ≤ 1) .

The positive electrode active material preferably includes at least one selected from the group consisting of the lithium cobalt composite oxide, the lithium manganese composite oxide, and the lithium phosphate having the olivine structure. The operating potentials of these active materials are 3.5 V (vs. Li/Li⁺) to 4.2 V (vs. Li/Li⁺) . Namely, the operating potentials of these active materials are relatively high. When these positive electrode active materials are used in combination with the above-described negative electrode active material such as the spinel structure lithium titanate or the anatase titanium oxide, a high battery voltage can be obtained.

The positive electrode active material may be contained in the positive electrode in a form of, for example, particles. The positive electrode active material particles may be single primary particles, secondary particles that are agglomerates of primary particles, or a mixture of primary particles and secondary particles. The shape of a particle is not particularly limited and may be, for example, spherical, elliptical, flat, or fibrous.

The average particle size (diameter) of the primary particles of the positive electrode active material is preferably 10 µm or less, and more preferably 0.1 µm to 5 µm. The average particle size (diameter) of the secondary particles of the positive electrode active material is preferably 100 µm or less, and more preferably 10 µm to 50 µm.

The primary particle size and the secondary particle size of the positive electrode active material can be measured by the same method as that for the negative electrode active material particles.

The positive electrode active material-containing layer may contain an electro-conductive agent, a binder, and the like in addition to the positive electrode active material. The electro-conductive agent is mixed as needed to raise current collection performance and suppress the contact resistance between the active material and the current collector. The binder has a function of binding the active material, the electro-conductive agent, and the current collector.

Examples of the electro-conductive agent include carbon materials such as acetylene black, Ketjen black, graphite, coke, carbon fiber, and carbon nanotube. The electro-conductive agent may be of one species, or two species or more may be used in mixture.

As the binder for the positive electrode, there may be used, for example, polytetrafluoroethylene (PTFE), polyvinylidene fluoride (PVdF), fluorine-based rubber, ethylene-butadiene rubber, polypropylene (PP), polyethylene (PE), carboxymethyl cellulose (CMC), polyimide (PI), polyacrylonitrile (PAN), or the like. The binder may be of one species, or two species or more may be used in mixture.

The mixing ratios of the electro-conductive agent and binder with respect to 100 parts by mass of active material in the positive electrode active material-containing layer are preferably 0.1 part by mass to 20 parts by mass and 0.5 part by mass to 10 parts by mass, respectively. If the mixing ratio of the electro-conductive agent is 0.1 parts by mass or more, the electrical conductivity of the positive electrode can be favorable. If the mixing ratio of the electro-conductive agent is 20 parts by mass or less, decomposition of the aqueous electrolyte on the electro-conductive agent surface can be reduced. If the mixing ratio of the binder is 0.5 part by mass or more, a sufficient electrode strength can be obtained. If the mixing ratio of the binder is 10 parts by mass or less, the insulating portions in the electrode can be decreased.

The positive electrode can be obtained by, for example, the following method. First, the active material, electro-conductive agent, and binder are suspended in a suitable solvent to prepare a slurry. Next, the slurry is applied onto one surface or both surfaces of the current collector. The coating of applied slurry on the current collector is dried, thereby forming an active material-containing layer. After that, pressing is performed for the current collector and the active material-containing layer formed thereon. As the active material-containing layer, the mixture of the active material, electro-conductive agent, and binder may be formed into pellets and used.

### Separator

A separator may be disposed between the positive electrode and the negative electrode. By configuring the separator using electrically insulating materials, the positive and negative electrodes can be prevented from coming into electrical contact. It is desirable to use a separator having a shape which allows the electrolyte to move within the separator.

Examples of the separator include non-woven fabrics, films, and paper. Examples of a constituent material of the separator include polyolefin such as polyethylene and polypropylene; and cellulose. Preferable examples of the separator include cellulose fiber-containing non-woven fabrics and polyolefin fiber-containing porous films.

The separator preferably has a thickness of from 20 µm to 100 µm and a density of from 0.2 g/cm³ to 0.9 g/cm³. When the thickness and the density of the separator are respectively within the above ranges, balance can be maintained between the mechanical strength and a reduction in battery resistance, whereby there can be provided a secondary battery which has a high output and where there is suppression in occurrence of internal short circuits. In addition, there is little thermal shrinkage of the separator at high temperatures, and thus, a favorable high-temperature storage performance can be attained.

In addition, a solid electrolyte layer containing solid electrolyte particles may be used as the separator. The solid electrolyte layer may contain one species of solid electrolyte particles or may contain plural species of solid electrolyte particles. The solid electrolyte layer may be a composite film containing inorganic solid particles or solid electrolyte particles. For example, the composite film is obtained by molding inorganic solid particles or solid electrolyte particles into a film shape using a polymeric binder. In such a case, the composite film preferably includes an electrolyte salt.

Examples of the polymeric binder include a polyvinyl-based binder, a polyether-based binder, a polyester-based binder, a polyamine-based binder, a polyethylene-based binder, a silicone-based binder, and a polysulfide-based binder.

As a solid electrolyte, an inorganic solid electrolyte is preferably used. Examples of the inorganic solid electrolyte include an oxide-based solid electrolyte and a sulfide-based solid electrolyte. As the oxide-based solid electrolyte, a lithium phosphate solid electrolyte having a NASICON structure and represented by a general formula of LiMe₂(PO₄)₃ is preferably used. Me in the formula described above is preferably one or more selected from the group consisting of titanium (Ti) , germanium (Ge) , strontium (Sr) , zirconium (Zr), tin (Sn), and aluminum (Al) . The element Me preferably includes Al and one among Ge, Zr, and Ti.

Specific examples of the lithium phosphate solid electrolyte having the NASICON structure include LATP (Li₁₊ₖAlₖTi_{2—k} (PO₄)₃), Li₁₊ₖAlₖGe_{2—k} (PO₄)₃, and Li₁₊ₖAlₖZr_{2—k} (PO₄)₃. In the formulae described above, k falls within the range of 0 < k ≤ 5, and preferably falls within the range of 0.1 ≤ k ≤ 0.5. As the solid electrolyte, LATP is preferably used. LATP is excellent in water resistance and is unlikely to undergo hydrolysis within the secondary battery.

In addition to the above lithium phosphoric acid solid electrolyte, examples of the oxide-base solid electrolyte include amorphous LIPON compounds represented by Li₁POₚN_{q} where 2.6 ≤ 1 ≤ 3.5, 1.9 ≤ p ≤ 3.8, and 0.1 ≤ q ≤ 1.3 (e.g., Li_{2.9}PO_{3.3}N_{0.46}) ; a compound having a garnet structure and represented by La₅₊ₘXₘLa_{3—m}Mα₂O₁₂ where X is one or more selected from the group consisting of Ca, Sr, and Ba, Mα is one or more selected from the group consisting of Nb and Ta, and 0 ≤ m ≤ 0.5; a compound represented by Li3Mβ_{2—m}L₂O₁₂ where Mβ is one or more selected from the group consisting of Ta and Nb, and L may include Zr, and 0 ≤ m ≤ 0.5; a compound represented by Li_{7—3m}AlₘLa₃Zr₃O₁₂ where 0 ≤ m ≤ 0.5; and a LLZ compound represented by Li₅₊ₙLa₃Mγ_{2—n}ZrₙO₁₂ where Mγ is one or more selected from the group consisting of Nb and Ta, and 0 ≤ n ≤ 2 (e.g., Li₇La₃Zr₂O₁₂).

In addition, as the solid electrolyte, a sodium-containing solid electrolyte may be used. The sodium-containing solid electrolyte is excellent in the ionic conductivity of sodium ions. Examples of the sodium-containing solid electrolyte include β-alumina, sodium phosphorus sulfides, sodium phosphates, and the like. The sodium ion-containing solid electrolyte is preferably in a form of glass ceramics.

As inorganic solid particles contained in the composite film besides the solid electrolyte particles, examples include oxide-based ceramics such as alumina, silica, zirconia, yttria, magnesium oxide, calcium oxide, barium oxide, strontium oxide, and vanadium oxide, carbonates and sulfates such as sodium carbonate, potassium carbonate, magnesium carbonate, calcium carbonate, barium carbonate, lanthanum carbonate, cerium carbonate, calcium sulfate, magnesium sulfate, aluminum sulfate, gypsum, and barium sulfate, phosphates such as hydroxyapatite, lithium phosphate, zirconium phosphate, and titanium phosphate, and nitride-based ceramics such as silicon nitride, titanium nitride, and boron nitride. The inorganic particles mentioned above may be in the form of a hydrate.

As the electrolyte salt which may be contained in the composite film, the lithium salt or sodium salt that may be contained in the aqueous electrolyte may be used.

The proportion of the electrolyte salt in the solid electrolyte layer is preferably from 0.01% by mass to 10% by mass, and more preferably from 0.05% by mass to 5% by mass. The proportion of the electrolyte salt in the solid electrolyte layer can be calculated by thermogravimetric (TG) analysis.

Whether the solid electrolyte layer contains an electrolyte salt can be examined, for example, based on an alkali metal ion distribution obtained by energy dispersive X-ray spectrometry (EDX) for a section of the solid electrolyte layer. That is, if the solid electrolyte layer is made of a material that does not contain an electrolyte salt, the alkali metal ions remain at the surface of the polymeric material in the solid electrolyte layer, and therefore, are scarcely present inside the solid electrolyte layer. Hence, there may be observed a concentration gradient where the concentration of alkali metal ions is high at the surface of the solid electrolyte layer, while the concentration of alkali metal ions is low inside the solid electrolyte layer. On the other hand, if the solid electrolyte layer is made of a material containing an electrolyte salt, it would be confirmed that the alkali metal ions are evenly present within the solid electrolyte layer, to the extent of the interior.

Alternatively, if the electrolyte salt contained in the solid electrolyte layer and the electrolyte salt contained in the aqueous electrolyte are of different species, based on the difference in ions that are present, it can be found that the solid electrolyte layer contains an electrolyte salt different from that in the aqueous electrolyte. For example, when lithium chloride (LiCl) is used for the aqueous electrolyte, and LiTFSI (lithium bis(fluorosulfonyl) imide) is used for the solid electrolyte layer, the presence of (fluorosulfonyl) imide ions would be confirmed in the solid electrolyte layer. On the other hand, in the aqueous electrolyte, the presence of the (fluorosulfonyl)imide ions would not be confirmed, or the (fluorosulfonyl)imide ions would be present at an exceptionally low concentration.

### Container Member

As the container member that houses the electrode and the aqueous electrolyte, a metal container, a laminated film container, or a resin container may be used.

As the metal container, a metal can made of nickel, iron, stainless steel, or the like and having a prismatic shape or a cylindrical shape may be used. As the resin container, a container made of polyethylene, polypropylene, or the like may be used.

The plate thickness of each of the resin container and the metal container preferably falls within the range of 0.05 mm to 1 mm. The plate thickness is more preferably 0.5 mm or less, and even more preferably 0.3 mm or less.

As the laminated film, for example, a multilayered film formed by covering a metal layer with resin layers may be used. Examples of the metal layer include a stainless steel foil, an aluminum foil, and an aluminum alloy foil. As the resin layer, a polymer such as polypropylene (PP), polyethylene (PE), nylon, or polyethylene terephthalate (PET) may be used. The thickness of the laminated film preferably falls within the range of 0.01 mm to 0.5 mm. The thickness of the laminated film is more preferably 0.2 mm or less.

### Negative Electrode Terminal

The negative electrode terminal may be formed, for example, from a material that is electrochemically stable at the potential of alkali metal ion insertion/extraction of the negative electrode active material and has electrical conductivity. Specifically, the material for the negative electrode terminal may include zinc, copper, nickel, stainless steel, aluminum, or an aluminum alloy containing at least one selected from the group consisting of Mg, Ti, Zn, Mn, Fe, Cu, and Si. As the material for the negative electrode terminal, zinc or a zinc alloy is preferably used. In order to reduce the contact resistance between the negative electrode terminal and the negative electrode current collector, the negative electrode terminal is preferably made of the same material as that of the negative electrode current collector.

### Positive Electrode Terminal

The positive electrode terminal is made, for example, of a material that is electrically stable in a potential range of 3 V to 4.5 V with respect to oxidation-reduction potential of lithium (vs. Li/Li⁺) and has electrical conductivity. Examples of the material for the positive electrode terminal include titanium, aluminum, or an aluminum alloy containing at least one selected from a group consisting of Mg, Ti, Zn, Mn, Fe, Cu, and Si. In order to reduce the contact resistance between the positive electrode terminal and the positive electrode current collector, the positive electrode terminal is preferably made of the same material as that of the positive electrode current collector.

The secondary battery according to the embodiment may be used in various forms such as a prismatic shape, a cylindrical shape, a flat form, a thin form, and a coin form. In addition, the secondary battery may be a secondary battery having a bipolar structure. A secondary battery having a bipolar structure has an advantage of being able to fabricate a cell with in-series connection of multiple, using a single cell.

An example of the secondary battery according to the embodiment will be described below with reference to the drawings.

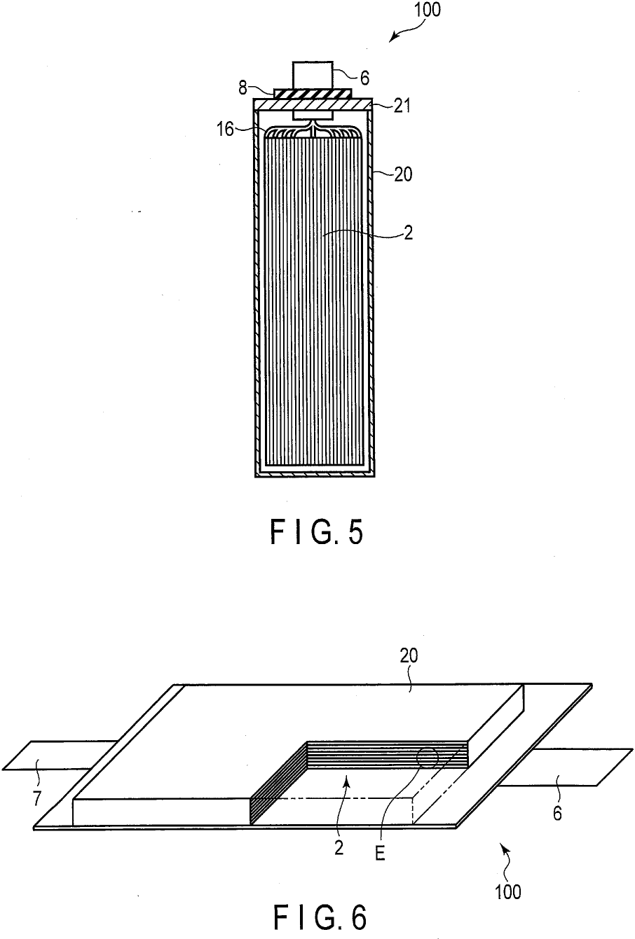

FIG. 4 is a sectional view schematically showing an example of the secondary battery according to the embodiment. FIG. 5 is a schematic sectional view of the secondary battery shown in FIG. 4 taken along a line V-V.

An electrode group 2 is housed in a container member 20 made of a rectangular tubular metal container. The electrode group 2 includes a negative electrode 3, a separator 4, and a positive electrode 5. The electrode group 2 has a structure formed by spirally winding the positive electrode 5 and the negative electrode 3 with the separator 4 interposing therebetween so as to form a flat shape. An aqueous electrolyte (not shown) is held by the electrode group 2 . As shown in FIG. 4, a strip-shaped negative electrode lead 16 is electrically connected to each of plural portions at an end of the negative electrode 5 located on an end face of the electrode group 2. In addition, a strip-shaped positive electrode lead 17 is electrically connected to each of plural portions at an end of the positive electrode 5 located on the end face. The plural negative electrode leads 16 are electrically connected to a negative electrode terminal 6 in a bundled state, as shown in FIG. 5. In addition, the plural positive electrode leads 17 are similarly electrically connected to a positive electrode terminal 7 in a bundled state, although not shown.

A sealing plate 21 made of metal is fixed to the opening portion of the container member 20 made of metal by welding or the like. The negative electrode terminal 6 and the positive electrode terminal 7 are extracted to the outside from outlet holes provided in the sealing plate 21, respectively. On the inner surfaces of the outlet holes of the sealing plate 21, a negative electrode gasket 8 and a positive electrode gasket 9 are arranged to avoid a short circuit caused by contact respective with the negative electrode terminal 6 and the positive electrode terminal 7. By providing the negative electrode gasket 8 and the positive electrode gasket 19, the airtightness of the secondary battery 100 can be maintained.

A control valve 22 (safety valve) is provided on the sealing plate 21. When the internal pressure of the battery cell is raised by gas generated by electrolysis of the aqueous solvent, the generated gas can be released from the control valve 22 to the outside. As the control valve 22 there may be used, for example, a return type valve that operates when the internal pressure exceeds a predetermined value and functions as a sealing plug when the internal pressure lowers. Alternatively, there may be used a non-return type valve that cannot recover the function as a sealing plug once it operates. In FIG. 4, the control valve 22 is disposed at the center of the sealing plate 21. However, the position of the control valve 22 may be an end of the sealing plate 21. The control valve 22 may be omitted.

Additionally, an inlet 23 is provided on the sealing plate 21. The aqueous electrolyte may be put in via the inlet 23. The inlet 23 may be closed with a sealing plug 24 after the aqueous electrolyte is put in. The inlet 23 and the sealing plug 24 may be omitted.

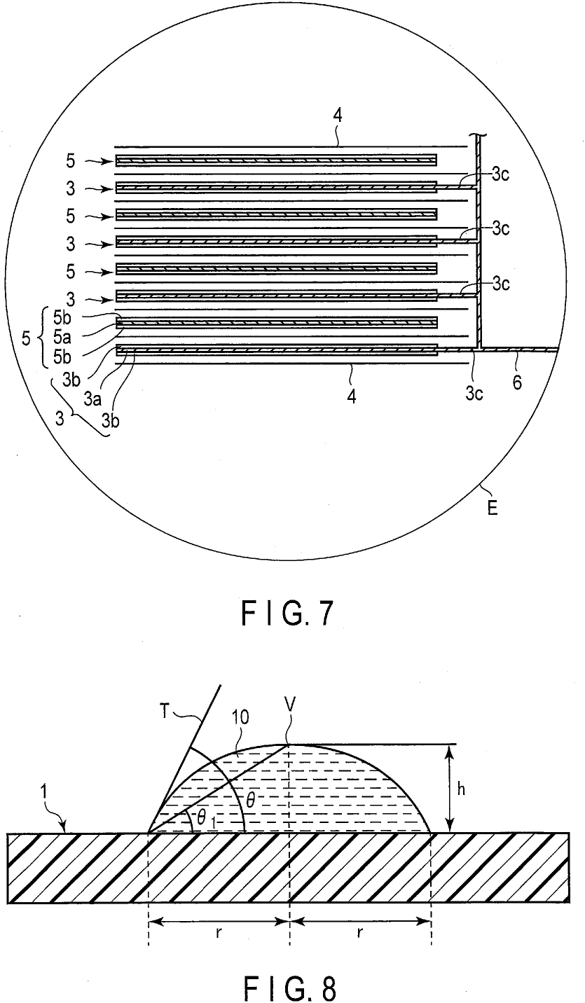

FIG. 6 is a partially cut out perspective view schematically showing another example of the secondary battery according to the embodiment. FIG. 7 is an enlarged sectional view of section E of the secondary battery shown in FIG. 6. FIG. 6 and FIG. 7 show an example of the secondary battery 100 using a laminated film container member as a container.

The secondary battery 100 shown in FIGS. 6 and 7 includes an electrode group 2 shown in FIGS. 6 and 7, a container member 20 shown in FIG. 6, and an aqueous electrolyte, which is not shown. The electrode group 2 and the aqueous electrolyte are housed in the container member 20. The aqueous electrolyte is held in the electrode group 2.

The container member 20 is made of a laminated film including two resin layers and a metal layer sandwiched between the resin layers.

As shown in FIG. 7, the electrode group 2 is a stacked electrode group. The stacked electrode group 1 has a structure in which negative electrodes 3 and positive electrodes 5 are alternately stacked with separator(s) 4 sandwiched therebetween.

The electrode group 2 includes plural negative electrodes 3. Each of the negative electrodes 3 includes a negative electrode current collector 3a and negative electrode active material-containing layers 3b supported on both surfaces of the negative electrode current collector 3a. The electrode group 2 further includes plural positive electrodes 5. Each of the positive electrodes 5 includes a positive electrode current collector 5a and positive electrode active material-containing layers 5b supported on both surfaces of the positive electrode current collector 5a.

The negative electrode current collector 3a of each of the negative electrodes 3 includes at one end, a portion 3c where the negative electrode active material-containing layer 3b is not supported on any surface. The portion 3c serves as a negative electrode current collecting tab. As shown in FIG. 7, the portion 3c serving as the negative electrode current collecting tab 3c does not overlap the positive electrode 5. Plural negative electrode current collecting tabs (portions 3c) are electrically connected to a belt-shaped negative electrode terminal 6. A leading end of the belt-shaped negative electrode terminal 6 is drawn to the outside from the container member 2.

Although not shown, the positive electrode current collector 5a of each of the positive electrodes 5 includes at one end a portion where the positive electrode active material-containing layer 5b is not supported on any surface. This portion serves as a positive electrode current collecting tab. Like the negative electrode current collecting tab (portion 3c), the positive electrode current collecting tab does not overlap the negative electrode 3. Further, the positive electrode current collecting tab is located on the opposite side of the electrode group 2 with respect to the negative electrode current collecting tab (portion 3c). The positive electrode current collecting tab is electrically connected to a belt-shaped positive electrode terminal 7. A leading end of the belt-shaped positive electrode terminal 7 is located on the opposite side of the negative electrode terminal 6 and drawn to the outside from the container member 20.

### Measurement Methods

Various measurement methods will be described. Specifically, a method for measuring the water absorption capacity of a resin matrix, contact angle with water, surface abundance ratios of various elements according to X-ray photoelectron spectroscopy (XPS), and solubility of an antioxidant, of the resin current collector contained in an electrode, will be described. Further, a method for measuring the electrode active material contained in the electrode will be described.

First, a secondary battery is discharged, the battery is disassembled, and electrodes are taken out. Specifically, a negative electrode and/or a positive electrode can be obtained by taking an electrode group out of a battery, and separating a negative electrode, a positive electrode, and a separator. The taken-out electrodes (negative electrode and/or positive electrode) are washed with pure water for 30 minutes. After that, the washed electrodes are vacuum dried for 24 hours under a temperature environment of 80° C. After the drying, the temperature is returned to 25° C., and an electrode sample is obtained.

A sample for performing the measurement for a resin current collector can be obtained by further separating an active material-containing layer from the current collector in the electrode sample. For example, the active material-containing layer is detached using a solvent. Alternatively, the active material-containing layer may be physically peeled off. In order to remove the components of the active material-containing layer that may remain on the current collector surface, the surface of the resin current collector is washed with a solvent. In order to avoid dissolving of the resin matrix, attention should be paid to the amount of solvent. By performing the washing and then drying, a resin current collector sample is obtained. As the solvent, for example, N-methyl-2-pyrrolidone is used.

### Measurement of Water Absorption Capacity of Resin Matrix

The water absorption capacity of a resin matrix can be measured as follows. A resin current collector sample is cut out to prepare a square sheet with 10 cm sides. The prepared sheet is vacuum dried for 24 hours under a temperature environment of 85° C. The weight of the resin current collector sheet after drying is measured, and then the sheet is immersed for 24 hours in water under room temperature (23° C.) . After the immersion, the sheet is dried, and the weight is measured again. The weight increase rate (wt%) before and after the immersion in water is calculated as the water absorption capacity (water absorption capacity = [ (weight after immersion - weight before immersion) / weight before immersion] × 100%).

### Measurement of contact angle with water

The contact angle with water of a resin current collector can be determined by calculating the static contact angle according to a drop method. Specifically, a water droplet with a droplet volume of 2 µL is put on a surface of a resin current collector sample, and the contact angle is calculated by a θ/2 method (half-angle method). A schematic sectional view representing an overview of the measurement is shown in FIG. 8 .

A water droplet 10 is put on a surface of a resin current collector 1. As the water for the droplet, for example, pure water is used, As for the sample shape and sample size of the resin current collector 1, so long as the surface onto which the droplet 10 is put is a flat surface, there is not particular limitation in other respects. The contact angle θ corresponds to the angle between the resin current collector 1 and the tangent line T to the droplet 10 passing through the end point of the droplet 10. As shown in the drawing, the value of the contact angle 6 is twice the value of the angle θ₁ between the resin current collector 1 and the straight line connecting the end point of the droplet 10 and the apex V. The angle θ₁ has a relationship (tan θ₁ = h/r) shown in the following formula 1 with the height h and radius r of the droplet 10, and thus the contact angle 9 that is twice the angle θ₁ can be calculated by using the height h and radius r of the droplet 10 based on the following formula 2 (θ = 2 arctan (h/r)).

$$\text{tan} {θ}_{1} = \frac{h}{r}$$

$$θ = 2 \text{arctan} \frac{h}{r}$$

### X-Ray Photoelectron Spectroscopy Measurement

The X-ray photoelectron spectroscopy (XPS) measurement can be carried out according to the method described below.

As an apparatus, for example, Quantera SXM, manufactured by ULVAC-PHI, is used. A 300 W monochromated—Al—Kα ray (radiation: 1486.6 eV) can be used. The measurement depth can be controlled by adjusting the photoelectron extraction angle . For example, when the photoelectron extraction angle is set to 45°, the measured depth is about 4 nm. The measurement area is set to 500 µm × 500 µm.

A current collector, which has been taken out from a battery disassembled in a glove box according to the above-described procedure, is attached onto an XPS analysis sample holder. Introduction of the sample is performed in an inert atmosphere, e.g., nitrogen atmosphere.

An abundance ratio (atom%) of atoms of measurement target, for example, fluorine (F) atoms, carbon (C) atoms, zinc (Zn) atoms, or oxygen (O) atoms, on the sample surface is determined. The atomic abundance ratio (atom %) for each element is calculated by multiplying relative sensitivity factors (RSF) on a peak area with the background subtracted, for a peak of each element. A Shirley method is used to subtract the background. For each peak, two points of a starting point and ending point of the peak is taken, and the background is subtracted using the Shirley method. Measurement points are arbitrarily selected at 5 positions and the abundance ratio of the measurement target atom is measured at each point, and the amount of atoms is determined by calculating the average value thereof.

The measurement of the sample surface, as referred to herein, indicates measurement at a measurement depth of a few nanometers from the outermost surface of the sample (e.g., 5 nm depth). By performing measurement at deeper measurement depths, for example, a depth of 0.1 µm, XPS measurement of the sample interior can be performed. For example, by comparing analysis results respectively of the surface measurement and the interior measurement, elements included in matter covering the resin current collector surface and atoms bonded to the resin on the current collector surface can be distinguished from the elements included in the polymer forming the resin matrix.

### Measurement of solubility of antioxidant

In a case where an antioxidant is contained in a resin current collector, the solubility of the antioxidant can be measured as follows.

First, compounds that have been added in the resin current collector are identified by mass spectrometry (MS), and an antioxidant is specified from among the compounds. A reagent of the compound that has been found to be an antioxidant is prepared. At room temperature (23° C.), 10 g of the reagent is charged in 100 g of water (100 mL), and irradiated with ultrasonic waves for 10 minutes . After the ultrasonic treatment, insoluble components are separated from the solution by a centrifugal separator. The insoluble components are recovered, and the weight of the insoluble components is measured. The solubility of the antioxidant can be calculated by subtracting the weight of the insoluble components from the weight at the time of charging (10 g), and dividing by the amount of water (100 mL) (solubility (g/mL) = [weight of charged reagent (g) - weight of insoluble components (g)] / amount of water (mL)]).

### Measurement of active material

The active material included in the electrode can be identified by combining elemental analysis with a scanning electron microscope equipped with an energy dispersive X-ray spectrometry scanning apparatus (scanning electron microscope-energy dispersive X-ray spectrometry; SEM-EDX), ICP emission spectrometry, and X-ray diffraction (XRD) measurement. By SEM-EDX analysis, shapes of components contained in the active material-containing layer and compositions of the components contained in the active material-containing layer (each element from B to U in the periodic table) can be known. The elements in the active material-containing layer can be quantified by ICP measurement. Crystal structures of materials included in the active material-containing layer can be examined by XRD measurement.

A cross-section of the electrode sample is cutout by Ar ion milling. The cutout cross-section is observed with the SEM. Sampling is performed in an inert atmosphere such as argon or nitrogen to avoid exposing the sample to the air. Several particles are selected from SEM images at 3000-fold magnification. Here, particles are selected such that a particle diameter distribution of the selected particles becomes as wide as possible.

Next, elemental analysis is performed on each selected particle by EDX. Accordingly, it is possible to specify kinds and quantities of elements other than Li among the elements contained in each selected particle.

With regard to Li, information regarding the Li content in the entire active material can be obtained by ICP emission spectrometry. ICP emission spectrometry is performed according to the following procedure.

From the dried electrode, a powder sample is prepared in the following manner. The active material-containing layer is dislodged from the current collector and ground in a mortar. The ground sample is dissolved with acid to prepare a liquid sample. Here, hydrochloric acid, nitric acid, sulfuric acid, hydrogen fluoride, and the like may be used as the acid. The components included in the active material being measured can be found by subjecting the liquid sample to ICP analysis.

Crystal structure(s) of compound(s) included in each of the particles selected by SEM can be specified by XRD measurement. XRD measurement is performed within a measurement range where 2θ is from 5 degrees to 90 degrees, using CuKα ray as a radiation source. By this measurement, X-ray diffraction patterns of compounds contained in the selected particles can be obtained.

As an apparatus for XRD measurement, SmartLab manufactured by Rigaku is used, for example. Measurement is performed under the following conditions:
X ray source: Cu target
Output: 45 kV, 200 mA
soller slit: 5 degrees in both incident light and received light
step width (2θ) : 0.02 deg
scan speed: 20 deg/min
semiconductor detector: D/teX Ultra 250
sample plate holder: flat glass sample plate holder (0.5 mm thick)
measurement range: range of 5° ≤ 2θ ≤ 90°

When another apparatus is used, measurement using a standard Si powder for powder X-ray diffraction is performed, so as to find conditions that provide measurement results of peak intensity, half width, and diffraction angle that are equivalent to the results obtained by the above apparatus, and measurement of the sample is performed with those conditions.

Conditions of the XRD measurement is set, such that an XRD pattern applicable to Rietveld analysis is obtained. In order to collect data for Rietveld analysis, specifically, the step width is made ⅓ to ⅕ of the minimum half width of the diffraction peaks, and the measurement time or X-ray intensity is appropriately adjusted in such a manner that the intensity at the peak position of strongest reflected intensity is 5,000 cps or more.

The XRD pattern obtained as described above is analyzed by the Rietveld method. In the Rietveld method, the diffraction pattern is calculated from the crystal structure model that has been estimated in advance. Here, estimation of the crystal structure model is performed based on analysis results of EDX and ICP. The parameters of the crystal structure (lattice constant, atomic coordinate, occupancy ratio, or the like) can be precisely analyzed by fitting all the calculated values with the measured values.

XRD measurement can be performed with the electrode sample directly attached onto a glass holder of a wide-angle X-ray diffraction apparatus. At this time, an XRD spectrum is measured in advance in accordance with the materials included in the resin current collector, and the position(s) of appearance of the peak (s) derived from the collector is grasped. In addition, the presence/absence of peak(s) of mixed substances such as an electro-conductive agent or a binder is also grasped in advance. If the peak (s) of the current collector overlaps the peak(s) of the active material, it is desirable to perform measurement with the active material-containing layer removed from the current collector. This is in order to separate the overlapping peaks when quantitatively measuring the peak intensities. If the overlapping peaks can be grasped beforehand, the above operations can be omitted, of course.

The secondary battery according to the first embodiment includes an electrode including a resin current collector and an aqueous electrolyte including water. The resin current collector includes a resin matrix and an electro-conductive filler. The secondary battery exhibits high energy density and excellent life performance.

### Second Embodiment

According to a second embodiment, a battery module is provided. The battery module includes plural of secondary batteries according to the first embodiment.

In the battery module, each of the single-batteries may be arranged to be electrically connected in series or in parallel, or may be arranged in combination of in-series connection and in-parallel connection.

An example of the battery module will be described next with reference to the drawings.

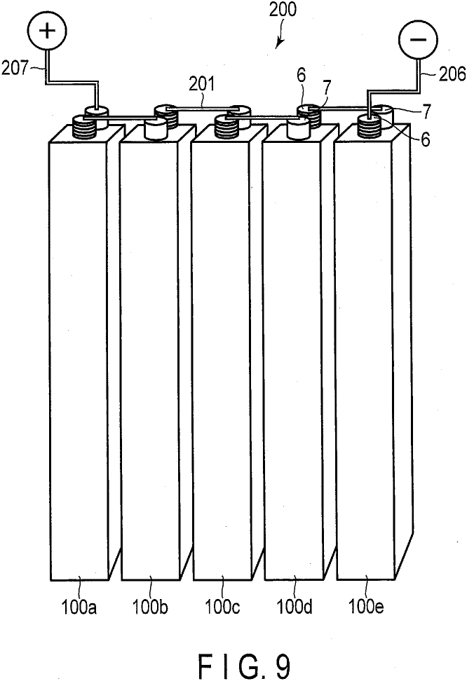

FIG. 9 is a perspective view schematically showing an example of the battery module. The battery module 200 shown in FIG. 9 includes five single-batteries 100a to 100e, four bus bars 201, a positive electrode-side lead 207, and a negative electrode-side lead 206. Each of the five single-batteries 100a to 100e is the secondary battery according to the first embodiment.

The bus bar 201 connects, for example, a negative electrode terminal 6 of one single-battery 100a and a positive electrode terminal 7 of the single-battery 100b positioned adjacent. In such a manner, five single-batteries 100 are thus connected in series by the four bus bars 201. That is, the battery module 200 shown in FIG. 9 is a battery module of five in-series connection. Although no example is depicted in drawing, in a battery module including plural single-batteries that are electrically connected in parallel, for example, the plural single-batteries may be electrically connected by having plural negative electrode terminals being connected to each other by bus bars while having plural positive electrode terminals being connected to each other by bus bars.

The positive electrode terminal 7 of at least one battery among the five single-batteries 100a to 100e is electrically connected to the positive electrode-side lead 207 for external connection. In addition, the negative electrode terminal 6 of at least one battery among the five single-batteries 100a to 100e is electrically connected to the negative electrode-side lead 206 for external connection.

The battery module according to the embodiment includes a secondary battery according to an embodiment. Therefore the battery module has high energy density and excellent life performance.

### Third Embodiment

According to a third embodiment, provided is a battery pack including the secondary battery according to the first embodiment. The battery pack may include a battery module according to the second embodiment. The battery pack may include a single secondary battery according to the first embodiment, in place of the battery module according to the second embodiment.

The battery pack may further include a protective circuit. The protective circuit has a function to control charging and discharging of the secondary battery. Alternatively, a circuit included in equipment where the battery pack serves as a power source (for example, electronic devices, vehicles, and the like) may be used as the protective circuit for the battery pack.

Moreover, the battery pack may further include an external power distribution terminal. The external power distribution terminal is configured to externally output electric current from the secondary battery, and/or to input external electric current into the secondary battery. In other words, when the battery pack is used as a power source, electric current is provided out via the external power distribution terminal. When the battery pack is charged, the charging current (including regenerative energy of motive force of vehicles such as automobiles) is provided to the battery pack via the external power distribution terminal.

Next, an example of a battery pack according to the embodiment will be described with reference to the drawings.

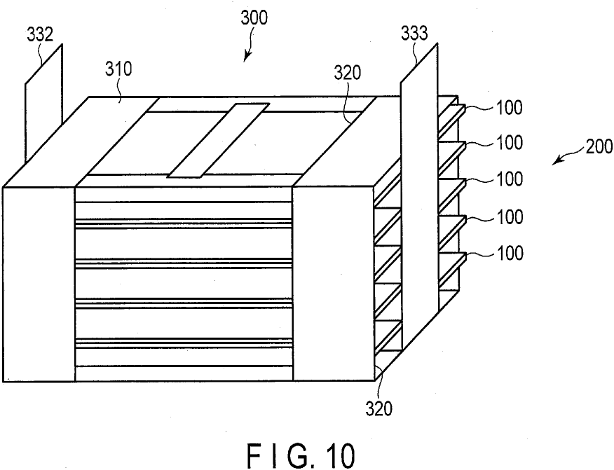

FIG. 10 is a perspective view schematically showing an example of the battery pack according to the embodiment.

A battery pack 300 includes a battery module configured of the secondary battery shown in FIGS. 6 and 7. The battery pack 300 includes a housing 310, and a battery module 200 housed in the housing 310. In the battery module 200, plural (for example, five) secondary batteries 100 are electrically connected in series. The secondary batteries 100 are stacked in a thickness direction. The housing 310 has an opening 320 on each of an upper portion and four side surfaces. The side surfaces, from which the positive and negative electrode terminals 6 and 7 of the secondary batteries 100 protrude, are exposed through the opening 320 of the housing 310. A positive electrode terminal 332 for output of the battery module 200 is belt-shaped, and one end thereof is electrically connected to any or all of the positive electrode terminals 7 of the secondary batteries 100, while the other end protrudes beyond the opening 320 of the housing 310 and thus protrudes past the upper portion of the housing 310. Meanwhile, a negative electrode terminal 333 for output of the battery module 200 is belt-shaped, and one end thereof is electrically connected to any or all of the negative electrode terminals 6 of the secondary batteries 100, while the other end protrudes beyond the opening 320 of the housing 310 and thus protrudes past the upper portion of the housing 310.

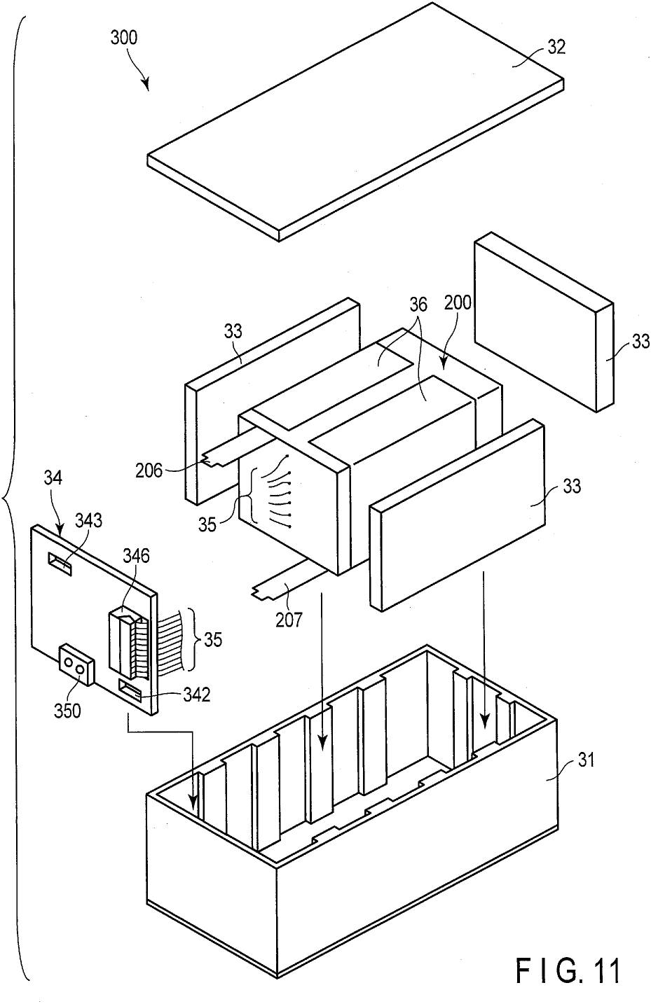

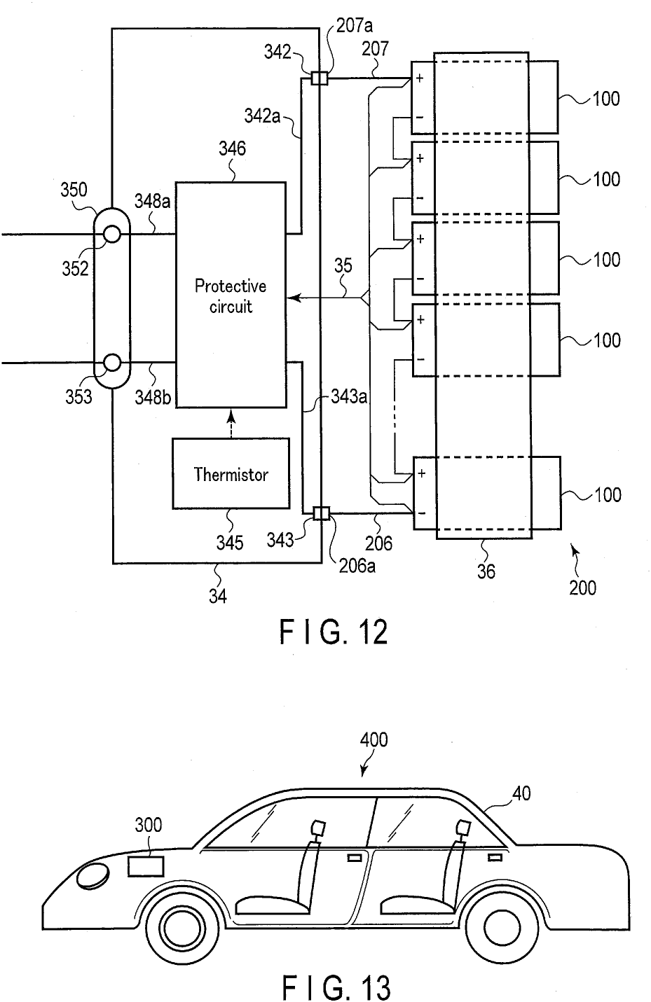

Another example of the battery pack is explained in detail with reference to FIG. 11 and FIG. 12. FIG. 11 is an exploded perspective view schematically showing another example of the battery pack according to the embodiment. FIG. 12 is a block diagram showing an example of an electric circuit of the battery pack shown in FIG. 11.

A battery pack 300 shown in FIGS. 11 and 12 includes a housing container 31, a lid 32, protective sheets 33, a battery module 200, a printed wiring board 34, wires 35, and an insulating plate (not shown).

The housing container 31 shown in FIG. 11 is a square-bottomed container having a rectangular bottom surface. The housing container 31 is configured to be capable of housing the protective sheets 33, the battery module 200, the printed wiring board 34, and the wires 35. The lid 32 has a rectangular shape. The lid 32 covers the housing container 31 to house the battery module 200 and such. Although not illustrated, the housing container 31 and the lid 32 are provided with openings, connection terminals, or the like for connection to an external device or the like.

The battery module 200 includes plural single-batteries 100, a positive electrode-side lead 207, a negative electrode-side lead 206, and adhesive tape(s) 36.

At least one of the plural single-batteries 100 is a secondary battery according to the embodiment. The plural single-batteries 100 are electrically connected in series, as shown in FIG. 12. The plural single-batteries 100 may alternatively be electrically connected in parallel, or connected in a combination of in-series connection and in-parallel connection. If the plural single-batteries 100 are connected in parallel, the battery capacity increases as compared to a case in which they are connected in series.

The adhesive tape(s) 36 fastens the plural single-batteries 100. The plural single-batteries 100 may be fixed using a heat shrinkable tape in place of the adhesive tape(s) 36. In this case, protective sheets 33 are arranged on both side surfaces of the battery module 200, and the heat shrinkable tape is wound around the battery module 200 and protective sheets 33. After that, the heat shrinkable tape is shrunk by heating to bundle the plural single-batteries 100.

One end of the positive electrode-side lead 207 is connected to the battery module 200. The one end of the positive electrode-side lead 207 is electrically connected to the positive electrode(s) of one or more single-battery 100. One end of the negative electrode-side lead 206 is connected to the battery module 200. The one end of the negative electrode-side lead 206 is electrically connected to the negative electrode(s) of one or more single-battery 100.

The printed wiring board 34 is provided along one face in the short side direction among the inner surfaces of the housing container 31. The printed wiring board 34 includes a positive electrode-side connector 342, a negative electrode-side connector 343, a thermistor 345, a protective circuit 346, wirings 342a and 343a, an external power distribution terminal 350, a plus-side wiring (positive-side wiring) 348a, and a minus-side wiring (negative-side wiring) 348b. One principal surface of the printed wiring board 34 faces one side surface of the battery module 200. An insulating plate (not shown) is disposed in between the printed wiring board 34 and the battery module 200.

The other end 207a of the positive electrode-side lead 207 is electrically connected to the positive electrode-side connector 342. The other end 206a of the negative electrode-side lead 206 is electrically connected to the negative electrode-side connector 343.

The thermistor 345 is fixed to one principal surface of the printed wiring board 34. The thermistor 345 detects the temperature of each single-battery 100 and transmits detection signals to the protective circuit 346.

The external power distribution terminal 350 is fixed to the other principal surface of the printed wiring board 34. The external power distribution terminal 350 is electrically connected to device(s) that exists outside the battery pack 300. The external power distribution terminal 350 includes a positive-side terminal 352 and a negative-side terminal 353.

The protective circuit 346 is fixed to the other principal surface of the printed wiring board 34. The protective circuit 346 is connected to the positive-side terminal 352 via the plus-side wiring 348a. The protective circuit 346 is connected to the negative-side terminal 353 via the minus-side wiring 348b. In addition, the protective circuit 346 is electrically connected to the positive electrode-side connector 342 via the wiring 342a. The protective circuit 346 is electrically connected to the negative electrode-side connector 343 via the wiring 343a. Furthermore, the protective circuit 346 is electrically connected to each of the plural single-batteries 100 via the wires 35.

The protective sheets 33 are arranged on both inner surfaces of the housing container 31 along the long side direction and on the inner surface along the short side direction facing the printed wiring board 34 across the battery module 200. The protective sheets 33 are made of, for example, resin or rubber.

The protective circuit 346 controls charge and discharge of the plural single-batteries 100. The protective circuit 346 is also configured to cut-off electric connection between the protective circuit 346 and the external power distribution terminal 350 (positive-side terminal 352, negative-side terminal 353) to external device(s), based on detection signals transmitted from the thermistor 345 or detection signals transmitted from each single-battery 100 or the battery module 200.

An example of the detection signal transmitted from the thermistor 345 is a signal indicating that the temperature of the single-battery(s) 100 is detected to be a predetermined temperature or more. An example of the detection signal transmitted from each single-battery 100 or the battery module 200 include a signal indicating detection of over-charge, over-discharge, and overcurrent of the single-battery(s) 100. When detecting over charge or the like for each of the single-batteries 100, the battery voltage may be detected, or a positive electrode potential or negative electrode potential may be detected. In the latter case, a lithium electrode to be used as a reference electrode may be inserted into each single-battery 100.

Note, that as the protective circuit 346, a circuit included in a device (for example, an electronic device or an automobile) that uses the battery pack 300 as a power source may be used.

As described above, the battery pack 300 includes the external power distribution terminal 350. Hence, the battery pack 300 can output electric current from the battery module 200 to an external device and input electric current from an external device to the battery module 200 via the external power distribution terminal 350. In other words, when using the battery pack 300 as a power source, the electric current from the battery module 200 is supplied to an external device via the external power distribution terminal 350. When charging the battery pack 300, a charge current from an external device is supplied to the battery pack 300 via the external power distribution terminal 350. If the battery pack 300 is used as an onboard battery, the regenerative energy of the motive force of a vehicle can be used as the charge current from the external device.

Note that the battery pack 300 may include plural battery modules 200. In this case, the plural battery modules 200 may be connected in series, in parallel, or connected in a combination of in-series connection and in-parallel connection. The printed wiring board 34 and the wires 35 may be omitted. In this case, the positive electrode-side lead 207 and the negative electrode-side lead 206 may respectively be used as the positive-side terminal and negative-side terminal of the external power distribution terminal.

Such a battery pack 300 is used, for example, in applications where excellent cycle performance is demanded when a large current is extracted. More specifically, the battery pack 300 is used as, for example, a power source for electronic devices, a stationary battery, or an onboard battery for various kinds of vehicles. An example of the electronic device is a digital camera. The battery pack 300 is particularly favorably used as an onboard battery.

The battery pack according to the third embodiment is provided with the secondary battery according to the first embodiment or the battery module according to the second embodiment. Accordingly, the battery pack has high energy density and excellent life performance.

### Fourth Embodiment

According to a fourth embodiment, provided is a vehicle including the battery pack according to the third embodiment.

In the vehicle, the battery pack is configured, for example, to recover regenerative energy from motive force of the vehicle. The vehicle may include a mechanism (e.g., a regenerator) for converting kinetic energy of the vehicle into regenerative energy.

Examples of the vehicle according to the embodiment include two- to four-wheeled hybrid electric automobiles, two-to four-wheeled electric automobiles, power assisted bicycles, and railway cars.

In the vehicle according to the embodiment, the installing position of the battery pack is not particularly limited. For example, the battery pack may be installed in the engine compartment of the vehicle, in rear parts of the vehicle, or under seats.

The vehicle according to the embodiment may have plural battery packs installed thereon. In such a case, batteries included in each of the battery packs may be electrically connected to each other in series, electrically connected in parallel, or electrically connected in a combination of in-series connection and in-parallel connection. For example, in a case where each battery pack includes a battery module, the battery modules may be electrically connected to each other in series, electrically connected in parallel, or electrically connected in a combination of in-series connection and in-parallel connection. Alternatively, in a case where each battery pack includes a single battery, each of the batteries may be electrically connected to each other in series, electrically connected in parallel, or electrically connected in a combination of in-series connection and in-parallel connection.

Next, an example of the vehicle according to the embodiment will be described with reference to the drawings.

FIG. 13 is a partially see-through diagram schematically showing an example of a vehicle according to the embodiment.

The vehicle 400 shown in FIG. 13 includes a vehicle body 40 and a battery pack 300 according to the third embodiment. In the example shown in FIG. 13, the vehicle 400 is a four-wheeled automobile.

This vehicle 400 may have plural battery packs 300 installed. In such a case, the batteries (single-batteries or battery modules) included in the battery packs 300 may be connected in series, connected in parallel, or connected in a combination of in-series connection and in-parallel connection.

In FIG. 13, the battery pack 300 is installed in an engine compartment located at the front of the vehicle body 40. As described above, the battery pack 300 may be installed in rear sections of the vehicle body 40, or under a seat. The battery pack 300 may be used as a power source of the vehicle 400. In addition, the battery pack 300 can recover regenerative energy of a motive force of the vehicle 400.

The vehicle according to the fourth embodiment has the battery pack according to the third embodiment installed therein. Therefore, the vehicle can exhibit high performance and has high reliability.

### Fifth Embodiment

According to a fifth embodiment, provided is a stationary power supply including the battery pack according to the third embodiment.

The stationary power supply may have the battery module according to the second embodiment or the secondary battery according to the first embodiment installed therein, instead of the battery pack according to the third embodiment. The stationary power supply can exhibit long life.

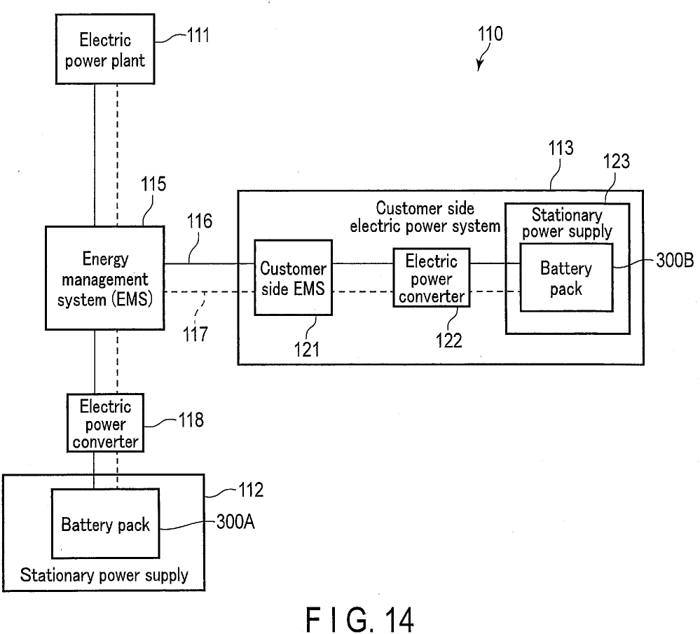

FIG. 14 is a block diagram showing an example of a system including the stationary power supply according to the embodiment. FIG. 14 is a diagram showing an application example to stationary power supplies 112, 123 as an example of use of battery packs 300A, 300B according to an embodiment. In the example shown in FIG. 14, shown is a system 110 in which the stationary power supplies 112, 123 are used. The system 110 includes an electric power plant 111, the stationary power supply 112, a customer side electric power system 113, and an energy management system (EMS) 115. Also, an electric power network 116 and a communication network 117 are formed in the system 110, and the electric power plant 111, the stationary power supply 112, the customer side electric power system 113 and the EMS 115 are connected via the electric power network 116 and the communication network 117. The EMS 115 performs control to stabilize the entire system 110 by utilizing the electric power network 116 and the communication network 117.

The electric power plant 111 generates a large capacity of electric power from fuel sources such as thermal power or nuclear power. Electric power is supplied from the electric power plant 111 through the electric power network 116 and the like. In addition, the battery pack 300A is installed in the stationary power supply 112. The battery pack 300A can store electric power and the like supplied from the electric power plant 111. In addition, the stationary power supply 112 can supply the electric power stored in the battery pack 300A through the electric power network 116 and the like. The system 110 is provided with an electric power converter 118. The electric power converter 118 includes a converter, an inverter, a transformer and the like. Thus, the electric power converter 118 can perform conversion between direct current (DC) and alternate current (AC), conversion between alternate currents of frequencies different from each other, voltage transformation (step-up and step-down) and the like. Therefore, the electric power converter 118 can convert electric power from the electric power plant 111 into electric power that can be stored in the battery pack 300A.

The customer side electric power system 113 includes an electric power system for factories, an electric power system for buildings, an electric power system for home use and the like. The customer side electric power system 113 includes a customer side EMS 121, an electric power converter 122, and the stationary power supply 123. The battery pack 300B is installed in the stationary power supply 123. The customer side EMS 121 performs control to stabilize the customer side electric power system 113.

Electric power from the electric power plant 111 and electric power from the battery pack 300A are supplied to the customer side electric power system 113 through the electric power network 116. The battery pack 300B can store electric power supplied to the customer side electric power system 113. Similarly to the electric power converter 118, the electric power converter 122 includes a converter, an inverter, a transformer and the like. Thus, the electric power converter 122 can perform conversion between direct current and alternate current, conversion between alternate currents of frequencies different from each other, voltage transformation (step-up and step-down) and the like. Therefore, the electric power converter 122 can convert electric power supplied to the customer side electric power system 113 into electric power that can be stored in the battery pack 300B.

Note that the electric power stored in the battery pack 300B can be used, for example, for charging a vehicle such as an electric automobile. Also, the system 110 may be provided with a natural energy source . In such a case, the natural energy source generates electric power by natural energy such as wind power and solar light. In addition to the electric power plant 111, electric power is also supplied from the natural energy source through the electric power network 116.

### EXAMPLES

Hereinafter, the above embodiments will be specifically described by referring to examples, however, the present invention is not limited to these examples as long as the spirit of the present invention is not departed.

### Production of Secondary Battery

### Example 1

### Fabrication of Current Collector

100 parts by mass of polypropylene (PP) as a polymeric material for forming a resin matrix and 80 parts by mass of carbon black as an electro-conductive filler were prepared. PP is a polymeric material having a water absorption capacity of less than 0.01%. A step of melting and kneading the prepared polymeric material and electro-conductive filler by a twin-screw extruder under the conditions of 200° C., 100 rpm, and a retention time of 5 minutes was repeated twice to obtain a resin current collector material. The obtained resin current collector material was rolled by a heat roll press machine so as to have a thickness of 30 µm to prepare a resin current collector.

### Fabrication of Positive Electrode

First, a positive electrode active material, an electro-conductive agent, a binder, and a solvent were mixed to prepare a slurry for a positive electrode. As the positive electrode active material, LiMn₂O₄ (LiMnO) having a spinel structure with an average particle size of 10 µm was used. As the electro-conductive agent, graphite powder was used. As the binder, PVdF was used. As the solvent, N-methyl-2-pyrrolidone (NMP) was used. The mass ratio of the positive electrode active material, the electro-conductive agent, and the binder in the slurry was set to 80 : 10 : 10. This slurry was applied onto both surfaces of the above resin current collector, and dried, and then a pressing treatment was implemented to obtain a positive electrode.

### Fabrication of Negative Electrode

Next, a negative electrode active material, an electro-conductive agent, a binder, and a solvent were mixed to prepare a slurry for a negative electrode. As the negative electrode active material, Li₄Ti₅O₁₂ (LTO) having an average secondary particle size of 15 µm was used. As the electro-conductive agent, graphite powder was used. As the binder, PVdF was used. As the solvent, NMP was used. The mass ratio of the negative electrode active material, the electro-conductive agent, and the binder in the slurry was set to 90 : 5 : 5. This slurry was applied onto both surfaces of the above resin current collector, and dried, and then a pressing treatment was implemented to obtain a negative electrode.

### Fabrication of Secondary Battery

Next, an electrolyte salt and water were mixed to prepare an aqueous electrolyte. As the electrolyte salt, lithium chloride was used. The concentration of the electrolyte salt in the aqueous electrolyte was set to 12 mol/L, and by the addition of 0.1 wt% zinc chloride to the electrolyte, an aqueous electrolyte was obtained.

A positive electrode, a separator, a negative electrode, and a second separator were stacked in this order to obtain a stack. As each separator, cellulose nonwoven fabric was used. The stack was spirally wound so that the negative electrode was located on the outermost circumference, and then the pressing was performed to prepare a flat electrode group. The obtained electrode group was housed in a metal can, and the aqueous electrolyte was put into the metal can to prepare a secondary battery.

### Initial Charge and Discharge

After putting in the aqueous electrolyte, the secondary battery was left to stand for 24 hours under an environment of 25° C. After that, the battery was subjected to initial charge and discharge under the environment of 25° C. In the initial charge and discharge, the battery was first charged to 2.8 V at 1A, and then discharged to 2.0 V at 1A, and the capacity of the battery was examined.

### Example 2

A secondary battery was produced by a method similar to that in Example 1 except that the electro-conductive filler was changed to 80 parts by mass of aluminum powder in the resin current collector for the negative electrode.

### Example 3

A secondary battery was produced by a method similar to that in Example 1 except that the electro-conductive filler was changed to 80 parts by mass of titanium powder in the resin current collector for the positive electrode.

### Example 4

A secondary battery was produced by a method similar to that in Example 1 except that the electro-conductive filler was changed to 80 parts by mass of titanium powder in the resin current collector for the positive electrode, and further, the electro-conductive filler was changed to 80 parts by mass of aluminum powder in the resin current collector for the negative electrode.

### Example 5

A secondary battery was produced by a method similar to that in Example 1 except that a titanium foil having a thickness of 15 µm was used instead as the current collector for the positive electrode.

### Example 6

A secondary battery was produced by a method similar to that in Example 1 except that a zinc foil having a thickness of 30 µm was used instead as the current collector for the negative electrode.

### Example 7

100 parts by mass of modified-polyphenylene ether (m-PPE) as a polymeric material for forming a resin matrix and 80 parts by mass of carbon black as an electro-conductive filler were prepared. m-PPE is a polymeric material having a water absorption capacity of 0.07%. A step of melting and kneading the prepared polymeric material and electro-conductive filler by a twin-screw extruder under the conditions of 320° C., 100 rpm, and a retention time of 5 minutes was repeated twice to obtain a resin current collector material. The obtained resin current collector material was rolled by a heat roll press machine to prepare a resin current collector having a thickness of 30 µm. A secondary battery was produced by a method similar to that in Example 1 except that the obtained resin current collector was used instead as the current collector in both of the positive electrode and the negative electrode.

### Example 8

A resin current collector was prepared by a method similar to that in Example 1. The resin current collector prepared in a roll was arranged in a roll-to-roll system in a reaction vessel provided with a treatment preparation zone and a reaction treatment zone, so as to be transported from the treatment preparation zone to the reaction treatment zone and returned to the treatment preparation zone again. After replacing the entire vessel interior with nitrogen gas, the fluorine gas concentration of the atmosphere in the reaction treatment zone was adjusted so as to be 5% by volume, and a surface fluorination treatment was performed by transporting the current collector through the reaction treatment zone in 10 minutes . A secondary battery was produced by a method similar to that in Example 1 except that the obtained fluorinated resin current collector was used instead as the current collector for the positive electrode.

### Example 9

A resin current collector was prepared by a method similar to that in Example 1. A surface fluorination treatment was performed twice in total by repeating the treatment performed in Example 8. A secondary battery was produced by a method similar to that in Example 1 except that the obtained fluorinated resin current collector was used instead as the current collector for the positive electrode.

### Example 10

A secondary battery was produced by a method similar to that in Example 1 except that the fluorinated resin current collector prepared in Example 8 was used instead as the current collector for the negative electrode.

### Example 11

A secondary battery was produced by a method similar to that in Example 1 except that the fluorinated resin current collector prepared in Example 9 was used instead as the current collector for the negative electrode.

### Example 12

100 parts by mass of polypropylene as a polymeric material for forming a resin matrix, 80 parts by mass of carbon black as an electro-conductive filler, and 1.5 parts by mass of (±)-α-tocopherol as an antioxidant were prepared. A step of melting and kneading the prepared polymeric material, electro-conductive filler, and antioxidant by a twin-screw extruder under the conditions of 200° C., 100 rpm, and a retention time of 5 minutes was repeated twice to obtain a resin current collector material. The obtained resin current collector material was rolled by a heat roll press machine to prepare a resin current collector having a thickness of 30 µm. A secondary battery was produced by a method similar to that in Example 1 except that the obtained resin current collector to which the antioxidant had been added was used instead as the current collector for the positive electrode. In this regard, the solubility of (±) -α-tocopherol in 100 mL of water measured by the method described above was 0.5 g.

### Example 13

As an inner layer, a resin current collector was prepared by a method similar to that in Example 1. As surface layers, antioxidant-containing resin layers were prepared as follows. 100 parts by mass of polypropylene as a polymeric material for forming a resin matrix, 80 parts by mass of carbon black as an electro-conductive filler, and 3 parts by mass of (±)-α-tocopherol as an antioxidant were prepared. A step of melting and kneading the prepared polymeric material, electro-conductive filler, and antioxidant by a twin-screw extruder under the conditions of 200° C., 100 rpm, and a retention time of 5 minutes was repeated twice to obtain a resin current collector material. The obtained resin current collector material was rolled by a heat roll press machine to prepare resin current collector layers each having a thickness of 30 µm. By using two of the obtained antioxidant-containing resin layers as the surface layers, stacking the layers on both sides of the above inner layer, and rolling the layers again by a heat roll press machine to integrate them, a composite resin current collector layer having a thickness of 40 µm was prepared. A secondary battery was produced by a method to similar that in Example 1 except that the obtained multilayer current collector was used instead as the current collector for the positive electrode.

### Example 14

A resin current collector was prepared by a method similar to that in Example 1. By generating plasma on a surface of the resin current collector by microwaves and a magnetic field, a surface plasma treatment was performed. A secondary battery was produced by a method similar to that in Example 1 except that the resin current collector after the plasma treatment was used instead as the current collector for the negative electrode.

### Example 15

A resin current collector was prepared by a method similar to that in Example 1. The resin current collector was immersed in an aqueous solution of 1 M ZnCl, and zinc plating treatment was performed. The plating conditions were set to a current density of 1 A/dm², a plating time of 40 minutes, and a bath temperature of 25° C. A secondary battery was produced by a method similar to that in Example 1 except that the obtained zinc-plated resin current collector was used instead as the current collector for the negative electrode.

### Example 16

A secondary battery was produced by a method similar to that in Example 1 except that a niobium titanium composite oxide Nb₂TiO₇ (NTO) having an average particle size of 2 µm was used instead as the negative electrode active material.

### Example 17

A secondary battery was produced by a method similar to that in Example 1 except that a sodium niobium titanium composite oxide Li₂Na_{1.8}Ti_{5.8}Nb_{0.2}O₁₄ (LNT) having an average particle size of 2 µm was used instead as the negative electrode active material.

### Example 18

A secondary battery was produced by a method similar to that in Example 1 except that a monoclinic titanium dioxide (TiO₂(B)) having an average particle size of 2 µm was used instead as the negative electrode active material.

### Example 19

A secondary battery was produced by a method similar to that in Example 1 except that a nickel cobalt manganese composite oxide LiNi_{0.5}Co_{0.2}Mn_{0.3}O₂ (NCM) having an average particle size of 10 µm was used instead as the negative electrode active material.

### Example 20

A secondary battery was produced by a method similar to that in Example 1 except that the fluorinated resin current collector prepared by a method similar to that in Example 9 was used instead in both of the positive electrode and the negative electrode.

### Example 21

A secondary battery was produced by a method similar to that in Example 1 except that the positive electrode prepared in Example 12 and the negative electrode prepared in Example 11 were used instead, respectively.

### Comparative Example 1

A secondary battery was produced by a method similar to that in Example 1 except that an aluminum foil having a thickness of 15 µm was used instead as the current collector for the positive electrode and the negative electrode.

### Comparative Example 2

A secondary battery was produced by a method similar to that in Example 1 except that a titanium foil having a thickness of 15 µm as the current collector for the positive electrode and a zinc foil having a thickness of 30 µm as the current collector for the negative electrode were used instead, respectively.

The details of the positive and negative electrodes prepared for the secondary batteries produced in Examples 1 to 21 and Comparative Examples 1 and 2 are summarized in the following Tables 1 and 2. Specifically, for each of the positive and negative electrodes, the active material, the materials for the current collector, and the form of the current collector are shown. For the active material, the term “LiMnO” represents LiMn₂O₄ with a spinel structure, the term “NCM” represents a nickel cobalt manganese composite oxide LiNi_{0.5}Co_{0.2}Mn_{0.3}O₂, the term “LTO” represents a lithium titanate Li₄Ti₅O₁₂ with a spinel structure, the term “NTO” represents a niobium titanium composite oxide Nb₂TiO₇ with a monoclinic crystal structure, the term “LNT” represents a sodium niobium titanium composite oxide Li₂Na_{1.8}Ti_{5.8}Nb_{0.2}O₁₄, and the term “TiO₂ (B) ” represents a monoclinic titanium dioxide. As the materials for the current collector, the polymeric material and electro-conductive filler used for forming the resin matrix are shown. As for the form of the current collector, a form like that in Example 1, in which there has not been any additive agent other than the electro-conductive filler contained in the resin matrix and where no surface treatment such as fluorination treatment has been performed, is indicated as “standard form” . In a case where a surface treatment was performed, the treatment details are shown. As for the fluorination treatment, the degree of fluorination is indicated as “vigorous” or “mild”. Further, the presence or absence of an antioxidant is also indicated as the form of the current collector. For Example 13 in which a resin current collector with a multilayer structure of surface layers each containing an antioxidant and an inner layer not containing an antioxidant was prepared, the form is also indicated as such.

TABLE 1

Positive Electrode

| | Active Material | Positive Electrode Current Collector | | |
|---|---|---|---|---|
| | | Polymeric Material | Electro-conductive Filler | Form |
| Example 1 | LiMnO | PP | Graphite | Standard Form |
| Example 2 | LiMnO | PP | Graphite | Standard Form |
| Example 3 | LiMnO | PP | Titanium | Standard Form |
| Example 4 | LiMnO | PP | Titanium | Standard Form |
| Example 5 | LiMnO | none | none | Titanium foil |
| Example 6 | LiMnO | PP | Graphite | Standard Form |
| Example 7 | LiMnO | m-PPE | Graphite | Standard Form |
| Example 8 | LiMnO | PP | Graphite | Fluorination treatment (mild) |
| Example 9 | LiMnO | PP | Graphite | Fluorination treatment (vigorous) |
| Example 10 | LiMnO | PP | Graphite | Standard Form |
| Example 11 | LiMnO | PP | Graphite | Standard Form |
| Example 12 | LiMnO | PP | Graphite | Antioxidant added |
| Example 13 | LiMnO | PP | Graphite | Antioxidant-added multilayer |
| Example 14 | LiMnO | PP | Graphite | Standard Form |
| Example 15 | LiMnO | PP | Graphite | Standard Form |
| Example 16 | LiMnO | PP | Graphite | Standard Form |
| Example 17 | LiMnO | PP | Graphite | Standard Form |
| Example 18 | LiMnO | PP | Graphite | Standard Form |
| Example 19 | NCM | PP | Graphite | Standard Form |
| Example 20 | LiMnO | PP | Graphite | Fluorination treatment (vigorous) |
| Example 21 | LiMnO | PP | Graphite | Antioxidant added |
| Comparative Example 1 | LiMnO | none | none | Aluminum foil |
| Comparative Example 2 | LiMnO | none | none | Aluminum foil |

TABLE 2

Negative Electrode

| | | | | |
|---|---|---|---|---|
| | Active Material | Positive Electrode Current Collector | | |
| | | Polymeric Material | Electro-conductive Filler | Form |
| Example 1 | LTO | PP | Graphite | Standard form |
| Example 2 | LTO | PP | Aluminum | Standard form |
| Example 3 | LTO | PP | Graphite | Standard form |
| Example 4 | LTO | PP | Aluminum | Standard form |
| Example 5 | LTO | PP | Graphite | Standard form |
| Example 6 | LTO | none | none | Zinc foil |
| Example 7 | LTO | m-PPE | Graphite | Standard form |
| Example 8 | LTO | PP | Graphite | Standard form |
| Example 9 | LTO | PP | Graphite | Standard form |
| Example 10 | LTO | PP | Graphite | Fluorination treatment (mild) |
| Example 11 | LTO | PP | Graphite | Fluorination treatment (vigorous) |
| Example 12 | LTO | PP | Graphite | Standard form |
| Example 13 | LTO | PP | Graphite | Standard form |
| Example 14 | LTO | PP | Graphite | Surface plasma treatment () |
| Example 15 | LTO | PP | Graphite | Surface zinc plating treatment |
| Example 16 | NTO | PP | Graphite | Standard form |
| Example 17 | LNT | PP | Graphite | Standard form |
| Example 18 | TiO₂(B) | PP | Graphite | Standard form |
| Example 19 | LTO | PP | Graphite | Standard form |
| Example 20 | LTO | PP | Graphite | Fluorination treatment (vigorous) |
| Example 21 | LTO | PP | Graphite | Fluorination treatment (vigorous) |
| Comparative Example 1 | LTO | none | none | Aluminum foil |
| Comparative Example 2 | LTO | none | none | Zinc foil |

### Cycle test

A charge and discharge cycle test was performed on each of the produced secondary batteries under the following conditions. The charge and discharge were performed under the environment of 25° C. A series of operations, in which the secondary battery is charged to 2.8 V at a constant current of 1 A, then 10 minutes of rest is provided, and subsequently the secondary battery is discharged to 2.0 V at a constant current of 1 A, then 10 minutes of rest is provided again, was taken as one charge and discharge cycle. This charge and discharge cycle was repeated 50 times on the secondary battery.

At the time of the discharge in the 50th cycle, the charge capacity and the discharge capacity were measured, respectively. The charge-discharge efficiency at the 50th cycle was calculated by dividing the discharge capacity by the charge capacity at the 50th cycle (charge and discharge efficiency at the 50th cycle (%) = [discharge capacity at the 50th cycle / charge capacity at the 50th cycle] × 100%) . Further, the capacity at the 50th time relative to the initial capacity measured at the time of initial charge and discharge was calculated, whereby the capacity retention rate at the 50th cycle was determined (capacity retention rate at the 50th cycle (%) = [discharge capacity at the 50th cycle / initial discharge capacity] × 100%). Respective results are shown in the following Table 3.

In Table 3, the column “Charge-discharge efficiency at 50th cycle (%) ” shows the discharge capacity relative to the charge capacity in the 50th cycle as a percentage. The column “capacity retention ratio at 50th cycle (%)” shows the capacity (Capacity retention ratio) after 50 cycles relative to the initial capacity as a percentage. Further, the column “Weight proportion relative to Comparative Example 1” shows the proportion when the weight of the cell used in Comparative Example 1 is taken as “1”.

TABLE 3

Battery performance

| | Weight proportion relative to Comparative Example 1 | Charge-discharge efficiency at 50th cycle (%) | Capacity retention ratio at 50th cycle (%) |
|---|---|---|---|
| Example 1 | 0.77 | 85 | 98 |
| Example 2 | 0.79 | 83 | 97 |
| Example 3 | 0.82 | 85 | 97 |
| Example 4 | 0.86 | 85 | 97 |
| Example 5 | 0.95 | 86 | 97 |
| Example 6 | 1.05 | 88 | 98 |
| Example 7 | 0.78 | 85 | 97 |
| Example 8 | 0.77 | 86 | 98 |
| Example 9 | 0.78 | 89 | 98 |
| Example 10 | 0.77 | 88 | 98 |
| Example 11 | 0.78 | 91 | 98 |
| Example 12 | 0.79 | 85 | 98 |
| Example 13 | 0.81 | 85 | 98 |
| Example 14 | 0.79 | 88 | 99 |
| Example 15 | 0.79 | 86 | 99 |
| Example 16 | 0.81 | 85 | 95 |
| Example 17 | 0.79 | 84 | 97 |
| Example 18 | 0.8 | 88 | 96 |
| Example 19 | 0.77 | 85 | 95 |
| Example 20 | 0.78 | 90 | 98 |
| Example 21 | 0.79 | 88 | 98 |
| Comparative Example 1 | 1 | 60 | 15 |
| Comparative Example 2 | 1.4 | 86 | 98 |

### Surface analysis by X-ray photoelectron spectroscopy

For the secondary batteries according to Examples 8 to 11, which were subjected to a water-repellent treatment by fluorination, the battery after evaluation was disassembled, and the current collector was collected and subjected to surface analysis by measurement with X-ray photoelectron spectroscopy (XPS) as described below.

For Examples 8 and 9, the battery after the evaluation of secondary battery was disassembled, the positive electrode active material-containing layer was removed with a solvent, and the positive electrode resin current collector was taken out and used as a measurement sample. For Examples 10 and 11, the battery after the evaluation of secondary battery was disassembled, the negative electrode active material-containing layer was removed with a solvent, and the negative electrode resin current collector was taken out and used as a measurement sample.

An arbitrary measurement area of a square with 500 µm sides on a surface of the sample current collector was measured at a measurement depth of 5 nm by using monochromated—Al—Kα rays as an X-ray source with an X-ray photoelectron spectroscopic analyzer. The amounts of fluorine atoms and carbon atoms (abundance ratio: atom%) were calculated from the spectra obtained from the sample surface. In the measurement, arbitrary five points were measured, and the average values of the fluorine atoms and the carbon atoms were determined, respectively. The results are shown in the following Tables 4 and 5.

Further, for the secondary batteries according to Examples 1, 14, and 15, the battery after evaluation was disassembled, and the negative electrode current collector was collected and subjected to surface analysis for zinc and/or oxygen by similar measurement with XPS. For Examples 1, 14, and 15, in addition to the “current collector surface” at a measurement depth of 5 nm, the “inside” at a depth of 0.1 µm was also measured. Arbitrary five points were measured at each depth, and the average values of the zinc atoms and the oxygen atoms were determined, respectively. The results are shown in the following Table 5.

### Measurement of contact angle with water

For the positive electrode current collectors collected from Examples 1, 8, and 9 and the negative electrode current collectors collected from Examples 1, 10, and 11, the contact angle with water was also measured. The measurement was performed by the method described above. The measurement results are shown in the following Table 5.

The results of the above measurement with XPS and measurement for contact angle are summarized in Tables 4 and 5. Cells for which the respective measurement was not performed is marked as “-”.

TABLE 4

Measurement results with respect to positive electrode

| | Contact angle(°) | Amount of fluorine atoms on surface (atom%) | Amount of carbon atoms on surface (atom%) |
|---|---|---|---|
| Example 1 | 95 | — | — |
| Example 8 | 106 | 34 | 39 |
| Example 9 | 113 | 52 | 45 |

TABLE 5

Measurement results with respect to negative electrode

| | Contact angle(°) | Amount of fluorine atoms on surface (atom%) | Amount of carbon atoms on surface (atom%) | Amount of zinc atoms on surface (atom%) | Amount of zinc atoms at 0.1 µm depth (atom%) | Amount of oxygen atoms on surface (atom%) | Amount of oxygen atoms at 0.1 µm depth (atom%) |
|---|---|---|---|---|---|---|---|
| Example 1 | 95 | — | — | 29 | 0.1 | — | — |
| Example 10 | 105 | 34 | 39 | — | — | — | — |
| Example 11 | 110 | 52 | 45 | — | — | — | — |
| Example 14 | — | — | — | — | — | 12 | 0.1 |
| Example 15 | — | — | — | 45 | 0.1 | 5 | 0.1 |

As shown in Tables 4 and 5, in Examples 8 to 11, fluorine atoms bonded on a surface of the positive electrode current collector or negative electrode current collector were observed, and it was confirmed that at least part of the hydrocarbons in the resin matrix had been converted to a fluorine compound. Further, the larger the amount of fluorine is, the larger the contact angle with water on the current collector surface is, and it can be recognized that the water repellency by fluorination treatment was achieved. Furthermore, by making the current collector surface water-repellent, the charge and discharge efficiency was further improved from that of a current collector not made water-repellent as in Example 1.

As shown in Table 5, it can be recognized that in Example 1, zinc or a zinc compound was deposited on a surface of the negative electrode current collector upon the charge and discharge of the secondary battery due to the addition of a zinc ion source (zinc chloride) to the electrolyte. In addition, in Example 14, oxygen atoms bonded on a surface of the resin current collector were observed, and it can be recognized that a polar group had been introduced onto the current collector surface by surface plasma treatment. In Example 15, it was confirmed that the surface of the resin current collector was coated with zinc by surface plating treatment, and oxygen atoms were imparted to the current collector surface.

As shown in Table 3, as a result of using an aluminum foil as the current collector as in Comparative Example 1, the corrosion reaction of aluminum proceeded on the positive electrode side, and the battery performance was significantly deteriorated upon repetition of the charge-discharge cycle. In Comparative Example 2, since a titanium foil and a zinc foil each having corrosion tolerance were used, the charge-discharge performance itself was favorable. However, as a result of using these heavy metal materials for the current collectors of both the positive and negative electrodes, the weight of the secondary battery had increased, and it cannot be deemed that the energy density per weight is high.

In the secondary batteries according to Examples 1 to 12, by using a resin current collector as the current collector, the weight was reduced while maintaining the cycle life performance equal to that in Comparative Example 2. Further, on both the positive electrode side and the negative electrode side, improvement in the capacity retention ratio of the secondary battery was observed by applying water-repellent treatment to the resin current collector used or by introducing an antioxidant. In addition, for the resin current collector on the negative electrode side, further improvement in the life performance of the secondary battery was observed due to the improvement in the binding property with the active material-containing layer by the impartment of zinc or oxygen (polar group) onto the current collector surface.

According to at least one embodiment and example described above, provided is a secondary battery including an electrode containing a resin current collector that contains a resin matrix and an electro-conductive filler, and an aqueous electrolyte containing water. The electrode is lightweight and hardly reacts with the aqueous electrolyte; therefore, the secondary battery has high energy density and excellent life performance, and can provide a battery pack high in energy density and excellent in life performance, and a vehicle and stationary battery with the battery pack installed thereon.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A secondary battery comprising:
an electrode, the electrode comprising a resin current collector, the resin current collector comprising a resin matrix and an electro-conductive filler; and
an aqueous electrolyte comprising water.

2. The secondary battery according to claim 1, wherein the resin matrix has a water absorption capacity of 0.001 wt% or more and 0.5 wt% or less.

3. The secondary battery according to claim 1, wherein the electro-conductive filler comprises a carbon material.

4. The secondary battery according to claim 1, wherein a contact angle with water on a surface of the resin current collector is larger than 105°.

5. The secondary battery according to claim 1, wherein the resin current collector comprises fluorine on a surface thereof, and the fluorine is bonded to at least part of carbon comprised in the resin matrix.

6. The secondary battery according to claim 5, wherein a surface abundance ratio of the fluorine in the resin current collector is larger than a surface abundance ratio of the carbon in the resin current collector.

7. The secondary battery according to claim 1, wherein the resin current collector comprises an antioxidant.

8. The secondary battery according to claim 7, wherein the resin current collector has a multilayer structure comprising a surface layer and an inner layer, the surface layer comprises the antioxidant, and the inner layer does not comprise the antioxidant.

9. The secondary battery according to claim 7, wherein the resin current collector comprises 1 part by mass or more of the antioxidant relative to 100 parts by mass of the resin matrix.

10. The secondary battery according to claim 7, wherein the antioxidant has a solubility in water of 4 g/100 mL or less at room temperature.

11. The secondary battery according to claim 1, wherein a surface abundance ratio of oxygen in the resin current collector is 1.2 times or more an abundance ratio of oxygen at a depth of 0.1 µm from a surface of the resin current collector, by X-ray photoelectron spectroscopy.

12. The secondary battery according to claim 1, wherein a surface abundance ratio of zinc in the resin current collector is 1.2 times or more an abundance ratio of zinc at a depth of 0.1 µm from a surface of the resin current collector, by X-ray photoelectron spectroscopy.

13. The secondary battery according to claim 1, wherein the electrode comprises a titanium-containing oxide.

14. A battery pack comprising the secondary battery according to claim 1.

15. The battery pack according to claim 14, further comprising an external power distribution terminal and a protective circuit.

16. The battery pack according to claim 14, further comprising plural of the secondary battery, the secondary batteries being electrically connected in series, in parallel, or in combination of in-series connection and in-parallel connection.

17. A vehicle comprising the battery pack according to claim 14.

18. The vehicle according to claim 17, which comprises a mechanism configured to convert kinetic energy of the vehicle into regenerative energy.

19. A stationary power supply comprising the battery pack according to claim 14.
